(19) United States
(12) Patent Application Publication
(10) Pub. No.: US 2016/0200624 A1
(43) Pub. Date: Jul. 14, 2016

(54) GLASS AND METHOD FOR PRODUCING SAME

(71) Applicant: Nippon Electric Glass Co., Ltd., Shiga (JP)

(72) Inventors: Atsushi MUSHIAKE, Shiga (JP); Yohei HOSODA, Shiga (JP); Takashi MURATA, Shiga (JP)

(73) Assignee: Nippon Electric Glass Co., Ltd., Shiga (JP)

(21) Appl. No.: 15/058,468

(22) Filed: Mar. 2, 2016

Related U.S. Application Data
(63) Continuation-in-part of application No. PCT/JP2014/073425, filed on Aug. 29, 2014.

(30) Foreign Application Priority Data
Sep. 3, 2013 (JP) 2013-182210
Sep. 3, 2013 (JP) 2013-182211
Jan. 6, 2014 (JP) 2014-000195
Jan. 6, 2014 (JP) 2014-000196
Feb. 6, 2014 (JP) 2014-021075

(51) Int. Cl. C03C 3/093; C03B 17/06; C03C 3/064

(52) U.S. Cl. CPC C03C 3/093; C03C 3/064; C03B 17/064

(57) ABSTRACT

Provided is a glass, which has a phase separation structure including at least a first phase and a second phase, and is used for an OLED device, in which a content of SiO₂ in the first phase is higher than a content of SiO₂ in the second phase.

### TECHNICAL FIELD

The present invention relates to a glass and a method of producing the same, and more particularly, to a phase separated glass having a light scattering function and a method of producing the same, and a glass having a property of being phase separated through heat treatment.

### BACKGROUND ART

In recent years, more and more energy has been consumed in a living space, such as a home, owing to, for example, spread, an increase in size, or multifunctionalization of home appliances. In particular, energy consumption of an illumination device has been increased. Therefore, an illumination device having high efficiency has been actively investigated.

Light sources for illumination are divided into “a directional light source” for illuminating a limited area and “a diffuse light source” for illuminating a wide area. An LED illumination device corresponds to the “directional light source” and has been adopted as an alternative to an incandescent lamp. On the other hand, an alternative light source to a fluorescent lamp, which corresponds to the “diffuse light source,” has been demanded, and its potential candidate is an organic electroluminescence (EL) (OLED) illumination device.

An OLED element is an element comprising: a glass sheet; a transparent conductive film as an anode; an OLED layer including one or a plurality of light emitting layers each formed of an organic compound exhibiting electroluminescence upon injection of an electrical current; and a cathode. For the OLED layer to be used in the OLED element, a low-molecular-weight coloring matter-based material, a conjugated polymer-based material, or the like is used. The light emitting layer is formed as a laminated structure with a hole injection layer, a hole transport layer, an electron transport layer, an electron injection layer, or the like. The OLED layer having such laminated structure is arranged between the anode and the cathode. When an electric field is applied between the anode and the cathode, a hole injected from a transparent electrode serving as the anode and an electron injected from the cathode recombine in the light emitting layer, and light is emitted upon excitation of a light emission center by recombination energy.

The OLED element has been investigated for applications to a mobile phone or a display, and some of the OLED elements have already been put in practical use. In addition, the OLED element has luminous efficiency comparable to that of a flat panel television using a liquid crystal display, a plasma display, or the like.

However, brightness of the OLED element does not still reach a practical level in view of its application to the light source for illumination. Therefore, the luminous efficiency is required to be further improved.

A reason for the low brightness is that light is trapped in the glass sheet owing to a difference in refractive index between the glass sheet and air. For example, when a glass sheet having a refractive index n_{d} of 1.5 is used, a critical angle is calculated to be 42° by Snell's law based on the refractive index n_{d} of air, 1.0. Therefore, light entering at an incident angle equal to or more than the critical angle is supposed to be totally reflected, trapped in the glass sheet, and not extracted into air.

### CITATION LIST

### Patent Literature

Patent Literature 1: JP 2012-25634 A

### SUMMARY OF INVENTION

### Technical Problem

In order to solve the above-mentioned problems, investigations have been made on formation of a light extracting layer between the transparent conductive film or the like and the glass sheet. For example, in Patent Literature 1, it is disclosed that a light extracting layer obtained by sintering a glass frit having a high refractive index is formed on the surface of a soda glass sheet, and the light extraction efficiency is enhanced by dispersing a scattering substance in the light extracting layer.

However, the formation of the light extracting layer on the surface of the glass sheet requires a printing step of applying glass paste onto the surface of the glass sheet. The printing step raises the production cost. Further, in the case of dispersing scattering particles in the glass frit, the transmittance of the light extracting layer lowers owing to absorption by the scattering particles themselves. Further, the glass frit disclosed in Patent Literature 1 has high raw material cost because of containing a rare metal oxide, such as Nb₂O₅, in a large amount.

The present invention has been made in view of the above-mentioned circumstances, and a technical object of the present invention is to devise a glass which allows an OLED element to have enhanced light extraction efficiency without forming a light extracting layer formed of a sintered compact, and exhibits excellent productivity, and a method of producing the same.

### Solution to Problem

As a result of extensive investigations, the inventors of the present invention have found that the above-mentioned technical object can be achieved by using a specific phase separated glass. Thus, the finding is proposed as the present invention (first invention). Specifically, a glass according to a first embodiment of the present invention (first invention) has a phase separation structure comprising at least a first phase and a second phase, and is used for an OLED device, wherein a content of SiO₂ in the first phase is higher than a content of SiO₂ in the second phase. It should be noted that the “OLED device” includes not only an OLED illumination device, but also an OLED display and the like. In addition, light scattering accompanying the formation of the first phase and the second phase may be visually confirmed. In addition, each phase may be confirmed in detail by, for example, observing the surface of a sample after immersed in a 1 M hydrochloric acid solution for 10 minutes with a scanning electron microscope.

According to a first aspect, a glass according to the first embodiment of the present invention (first invention) has a phase separation structure comprising at least a first phase and a second phase, wherein a content of SiO₂ in the first phase is higher than a content of SiO₂ in the second phase. With this, when the glass is applied to an OLED device, incident light entering a glass sheet from an OLED layer is scattered at an interface between the first phase and the second phase, and hence the light extraction efficiency of an OLED element can be enhanced.

According to a second aspect, another glass according in the first embodiment of the present invention (first invention) has a phase separation structure comprising at least a first phase and a second phase, and is used for an OLED device, wherein a content of B₂O₃ in the second phase is higher than a content of B₂O₃ in the first phase. With this, when the glass is applied to an OLED device, incident light entering a glass sheet from an OLED layer is scattered at an interface between the first phase and the second phase, and hence the light extraction efficiency of an OLED element can be enhanced.

According to a third aspect, in the first embodiment of the present invention (first invention), the glass preferably comprises as a glass composition, in terms of mass %, 30% to 75% of SiO₂, 0.1% to 50% of B₂O₃, and 0% to 35% of Al₂O₃. With this, the phase separated glass is easily produced, and also the productivity of the glass sheet can be enhanced.

According to a fourth aspect, in the first embodiment of the present invention (first invention), the glass is preferably substantially free of a rare metal oxide in a glass composition. Now, the “rare metal oxide” as used herein refers to rare earth oxides, such as La₂O₃, Nd₂O₃, Gd₂O₃, and CeO₂, and Y₂O₃, Nb₂O₅, and Ta₂O₅. In addition, the “substantially free of a rare metal oxide” refers to the case where the content of the rare metal oxide in the glass composition is 0.1 mass % or less.

According to a fifth aspect, in the first embodiment of the present invention (first invention), the glass preferably has a refractive index n_{d} of more than 1.50. One cause of low brightness is a problem of mismatch of refractive indices. Specifically, a transparent conductive film has a refractive index n_{d} of from 1.9 to 2.0, and the OLED layer has a refractive index n_{d} of from 1.8 to 1.9. In contrast, the glass sheet generally has a refractive index n_{d} of about 1.5. Therefore, a related-art OLED device has a problem of low light extraction efficiency, because the refractive indices of the glass sheet and the transparent conductive film or the like are largely different from each other, and hence incident light from the OLED layer is reflected at an interface between the glass sheet and the transparent conductive film or the like. Under such circumstance, when the refractive index n_{d} of the glass is controlled as described above, the difference in refractive index between the glass sheet and the transparent conductive film or the like is reduced, and incident light from the OLED layer is less liable to be reflected at the interface between the glass sheet and the transparent conductive film or the like. Herein, the “refractive index n_{d}” refers to a value at the d-line measured with a refractometer. For example, first, a rectangular parallelepiped sample measuring 25 mm×25 mm×about 3 mm is produced, and then the sample is subjected to annealing treatment in a temperature range of from (annealing point Ta+30° C.) to (strain point Ps−50° C.) at a cooling rate of 0.1° C./min. After that, the refractive index may be measured with a refractometer KPR-2000 manufactured by Shimadzu Corporation, while an immersion liquid having a matched refractive index n_{d} is allowed to penetrate into the sample.

According to a sixth aspect, in the first embodiment of the present invention (first invention), the glass preferably has a flat sheet shape, that is, the glass is preferably a glass sheet.

According to a seventh aspect, in the first embodiment of the present invention (first invention), the glass is preferably formed by an overflow down-draw method. With this, the surface accuracy of the glass sheet can be enhanced. Herein, the “overflow down-draw method” refers to a method comprising causing molten glass to overflow from both sides of a heat-resistant, trough-shaped structure, and subjecting the overflowing molten glass to down-draw downward while joining the flows of the overflowing molten glass at the lower end of the trough-shaped structure, to thereby form the molten glass into a glass sheet.

According to an eighth aspect, in the first embodiment of the present invention (first invention), the glass is preferably obtained without an additional heat treatment step. The glass is preferably phase separated in a forming step or an annealing (cooling) step immediately after the forming step. With this, the number of production steps of the glass is reduced, and the productivity of the glass can be enhanced.

According to a ninth aspect, in the first embodiment of the present invention (first invention), the glass is preferably used for an OLED illumination device.

According to a tenth aspect, in the first embodiment of the present invention (first invention), the glass preferably has a phase separation viscosity of 10^{7.0} dPa·s or less. With this, the glass is easily phase separated in the forming step and/or the annealing step, and hence the glass sheet having the phase separation structure is easily formed by a float method or the overflow down-draw method. This eliminates the need for an additional heat treatment step after the forming of the glass sheet, and hence the production cost of the glass sheet is easily reduced. It should be noted that the glass according to the first embodiment of the present invention (first invention) is preferably phase separated in the forming step and/or the annealing step, but may be phase separated in a step other than these steps, e.g. a melting step. Herein, the “phase separation viscosity” refers to a value obtained by measuring the viscosity of the glass at its phase separation temperature by a platinum sphere pull up method. The “phase separation temperature” refers to a temperature at which white turbidity is clearly observed in the glass when the glass is placed in a platinum boat and re-melted at 1,400° C., and the platinum boat is then moved to a gradient heating furnace and kept in the gradient heating furnace for 5 minutes.

According to an eleventh aspect, in the first embodiment of the present invention (first invention), the glass preferably has a haze value of from 1% to 100% at each wavelength of 435 nm, 546 nm, and 700 nm. With this, light is easily scattered in the glass, and hence is easily extracted to the outside. As a result, the light extraction efficiency is easily enhanced. Herein, the “haze value” refers to a value calculated by the expression (diffuse transmittance)×100/(total light transmittance). The “diffuse transmittance” refers to a value obtained through measurement in a thickness direction with a spectrophotometer (for example, UV-2500PC manufactured by Shimadzu Corporation). For example, a glass having both surfaces mirror polished may be used as a sample for the measurement. The “total light transmittance” refers to a value obtained through measurement in the thickness direction with a spectrophotometer (for example, UV-2500PC manufactured by Shimadzu Corporation). For example, a glass having both surfaces mirror polished may be used as a sample for the measurement.

According to a twelfth aspect, in the first embodiment of the present invention (first invention), the glass preferably exhibits higher current efficiency than current efficiency of a non-phase separated glass having a comparable refractive index n_{d} when incorporated into an OLED element. Herein, the “current efficiency” may be calculated by measuring front brightness of the glass after producing an OLED element through the use of the glass and arranging a brightness meter in a direction perpendicular to the thickness direction of the glass. The “comparable refractive index n_{d}” refers to a refractive index n_{d} falling within a range of the refractive index n_{d} of the glass±0.2.

According to a thirteenth aspect, an OLED device according to the first embodiment of the present invention (first invention) comprises the above-mentioned glass.

According to a fourteenth aspect, a composite substrate according to the first embodiment of the present invention (first invention) comprises a glass sheet and a substrate bonded to each other, wherein the glass sheet comprises the above-mentioned glass. With this, the glass sheet functions as a light scattering layer, and hence the light extraction efficiency of the OLED element can be enhanced by merely forming the glass sheet into a composite with the substrate. Further, when the glass sheet and the substrate are bonded to each other and the glass sheet is arranged on a side in contact with air, the scratch resistance of the composite substrate can be enhanced.

According to a fifteenth aspect, in the composite substrate according to the first embodiment of the present invention (first invention), the substrate preferably comprises a glass substrate. The glass substrate is excellent in a transmitting property, weather resistance, and heat resistance as compared to a resin substrate or a metal substrate.

According to a sixteenth aspect, in the composite substrate according to the first embodiment of the present invention (first invention), the substrate preferably has a refractive index n_{d} of more than 1.50. With this, reflection at an interface between the OLED layer and the substrate is suppressed, and hence light in the substrate is easily extracted to air.

According to a seventeenth aspect, in the composite substrate according to the first embodiment of the present invention (first invention), the glass sheet and the substrate are preferably bonded to each other through optical contact. This eliminates the need for an adhesive tape or a curing agent at the time of bonding, and hence can realize simplified bonding of the glass sheet and the substrate while increasing the transmittance of the composite substrate. It should be noted that, as the surfaces of the glass sheet and the substrate on bonded sides have higher surface accuracy (flatness), bonding strength obtained through the optical contact is increased more.

According to an eighteenth aspect, in the first embodiment of the present invention (first invention), the composite substrate is preferably used for an OLED device.

As a result of extensive investigations, the inventors of the present invention have also found that the above-mentioned technical object can be achieved by obtaining a phase separated glass through heat treatment and applying the glass to an OLED device. Thus, the finding is proposed as the present invention (second invention). Specifically, a method of producing a glass according to a second embodiment of the present invention (second invention) comprises: forming molten glass; and performing heat treatment on the resultant, to thereby obtain a glass which has a phase separation structure comprising at least a first phase and a second phase, and is used for an OLED device.

It should be noted that, the method according to the second embodiment of the present invention (second invention) includes not only the case of comprising performing heat treatment on glass which has not yet been phase separated, to thereby obtain the phase separated glass, but also the case of comprising performing heat treatment on glass which has already been phase separated. In the former case, a situation in which the concentration of a specific phase becomes locally too high in the forming and the glass is devitrified is easily avoided, and moreover, a phase separation property is easily controlled. In the latter case, heat treatment efficiency can be enhanced while the phase separation property is controlled. It should be noted that the presence or absence of the phase separation may be visually confirmed, but to be precise, may be confirmed by observing the surface of a sample after immersed in a 1 M hydrochloric acid solution for 10 minutes with a scanning electron microscope. This treatment allows elution of a phase rich in B₂O₃ with the hydrochloric acid solution, but not a phase rich in SiO₂. In addition, the “heat treatment” as used in the second embodiment of the present invention (second invention) means treatment involving raising a temperature to a temperature range in which the phase separation occurs after the forming and subsequent cooling to a temperature equal to or lower than an annealing point. Further, the “OLED device” as used in the second embodiment of the present invention (second invention) includes not only an OLED illumination device, but also an OLED display and the like.

In the method of producing a glass according to the second embodiment of the present invention (second invention), a glass which has a phase separation structure comprising at least a first phase and a second phase is obtained through the heat treatment. With this, when the resultant glass is applied to an OLED device, incident light from an OLED layer is scattered at an interface between the first phase and the second phase, and hence the light extraction efficiency of an OLED element can be enhanced.

In addition, optimal scattering characteristics vary depending on the element structure of the OLED device. Under such circumstance, when the heat treatment is performed after the forming of the molten glass, the phase separation property of the resultant glass can be controlled, and glasses having different scattering functions can be produced from the same preform glass material. As a result, the productivity of the glass can be enhanced.

Further, there is a problem in that the glass is liable to be devitrified when the glass is allowed to be phase separated in the forming. However, when the heat treatment is performed after the forming, the phase separation of the glass in the forming can be suppressed. As a result, the problem as described above is easily avoided. It should be noted that a phase separation phenomenon may be controlled by a glass composition, forming conditions, annealing conditions, and the like, as well as heat treatment conditions (a heat treatment temperature and a time period of heat treatment).

According to a second aspect, in the method of producing a glass according to the second embodiment of the present invention (second invention), a content of SiO₂ in the first phase is preferably higher than a content of SiO₂ in the second phase. With this, when the resultant glass is applied to the OLED device, incident light from the OLED layer is easily scattered at the interface between the first phase and the second phase, and hence the light extraction efficiency of the OLED element can be enhanced.

According to a third aspect, in the method of producing a glass according to the second embodiment of the present invention (second invention), a content of B₂O₃ in the second phase is preferably higher than a content of B₂O₃ in the first phase. With this, when the resultant glass is applied to the OLED device, incident light from the OLED layer is easily scattered at the interface between the first phase and the second phase, and hence the light extraction efficiency of the OLED element can be enhanced.

According to a fourth aspect, in the method of producing a glass according to the second embodiment of the present invention (second invention), the glass preferably comprises as a glass composition, in terms of mass %, 30% to 75% of SiO₂, 0.1% to 50% of B₂O₃, and 0% to 35% of Al₂O₃. With this, a specific phase separated glass is easily produced through the heat treatment, and also the productivity of a glass sheet can be enhanced.

According to a fifth aspect, in the method of producing a glass according to the second embodiment of the present invention (second invention), the glass is preferably substantially free of a rare metal oxide in a glass composition. Now, the “rare metal oxide” as used herein refers to rare earth oxides, such as La₂O₃, Nd₂O₃, Gd₂O₃, and CeO₂, and Y₂O₃, Nb₂O₅, and Ta₂O₅. In addition, the “substantially free of a rare metal oxide” refers to the case where the content of the rare metal oxide in the glass composition is 0.1 mass % or less.

According to a sixth aspect, in the method of producing a glass according to the second embodiment of the present invention (second invention), the glass preferably has a refractive index n_{d} of more than 1.50. One cause of low brightness is a problem of mismatch of refractive indices. Specifically, a transparent conductive film has a refractive index n_{d} of from 1.9 to 2.0, and the OLED layer has a refractive index n_{d} of from 1.8 to 1.9. In contrast, the glass sheet generally has a refractive index n_{d} of about 1.5. Therefore, a related-art OLED device has a problem of low light extraction efficiency, because the refractive indices of the glass sheet and the transparent conductive film or the like are largely different from each other, and hence incident light from the OLED layer is reflected at an interface between the glass sheet and the transparent conductive film or the like. Under such circumstance, when the refractive index n_{d} of the glass is controlled as described above, the difference in refractive index between the glass sheet and the transparent conductive film or the like is reduced, and incident light from the OLED layer is less liable to be reflected at the interface between the glass sheet and the transparent conductive film or the like. Herein, the “refractive index n_{d}” refers to a value at the d-line measured with a refractometer. For example, first, a rectangular parallelepiped sample measuring 25 mm×25 mm×about 3 mm is produced, and then the sample is subjected to annealing treatment in a temperature range of from (annealing point Ta+30° C.) to (strain point Ps−50° C.) at a cooling rate of 0.1° C./min. After that, the refractive index may be measured with a refractometer KPR-2000 manufactured by Shimadzu Corporation, while an immersion liquid having a matched refractive index n_{d} is allowed to penetrate into the sample.

According to a seventh aspect, in the method of producing a glass according to the second embodiment of the present invention (second invention), the forming preferably comprises forming the molten glass into a flat sheet shape.

According to an eighth aspect, in the method of producing a glass according to the second embodiment of the present invention (second invention), the forming is preferably performed by an overflow down-draw method. Herein, the “overflow down-draw method” refers to a method comprising causing molten glass to overflow from both sides of a heat-resistant, trough-shaped structure, and subjecting the overflowing molten glass to down-draw downward while joining the flows of the overflowing molten glass at the lower end of the trough-shaped structure, to thereby form the molten glass into a glass sheet.

According to a ninth aspect, in the method of producing a glass according to the second embodiment of the present invention (second invention), the obtained glass is preferably used for an OLED illumination device.

According to a tenth aspect, a glass according to the second embodiment of the present invention (second invention) is produced by the above-mentioned method of producing a glass.

According to an eleventh aspect, another glass according to the second embodiment of the present invention (second invention) has a property of being phase separated into at least a first phase and a second phase from a non-phase separated state through heat treatment, and is used for an OLED device.

According to a twelfth aspect, in the second embodiment of the present invention (second invention), the glass preferably has a haze value of from 5% to 100% at each wavelength of 435 nm, 546 nm, and 700 nm before the heat treatment. Herein, the “haze value” refers to a value calculated by the expression (diffuse transmittance)×100/(total light transmittance). The “diffuse transmittance” refers to a value obtained through measurement in a thickness direction with a spectrophotometer (for example, UV-2500PC manufactured by Shimadzu Corporation). For example, a glass having both surfaces mirror polished may be used as a sample for the measurement. The “total light transmittance” refers to a value obtained through measurement in the thickness direction with a spectrophotometer (for example, UV-2500PC manufactured by Shimadzu Corporation). For example, a glass having both surfaces mirror polished may be used as a sample for the measurement.

According to a thirteenth aspect, in the second embodiment of the present invention (second invention), the glass preferably has a haze value of from 0% to 80% at each wavelength of 435 nm, 546 nm, and 700 nm after the heat treatment.

### BRIEF DESCRIPTION OF DRAWINGS

FIG. 1 is an image obtained by observing the surface of Sample No. 2 according to [Example 2] (Sample No. 22 according to [Example 7]) with a scanning electron microscope after immersing the sample in a 1 M hydrochloric acid solution for 10 minutes.

FIG. 2 is an image obtained by observing the surface of Sample No. 9 according to [Example 2] (Sample No. 29 according to [Example 7]) with a scanning electron microscope after immersing the sample in a 1 M hydrochloric acid solution for 10 minutes.

FIG. 3 is an image obtained by observing the surface of Sample No. 10 according to [Example 2] (Sample No. 30 according to [Example 7]) with a scanning electron microscope after immersing the sample in a 1 M hydrochloric acid solution for 10 minutes.

FIG. 4 is an image obtained by observing the surface of Sample No. 11 according to [Example 2] (Sample No. 31 according to [Example 7]) with a scanning electron microscope after immersing the sample in a 1 M hydrochloric acid solution for 10 minutes.

FIG. 5 is an image obtained by observing the surface of Sample No. 12 according to [Example 2] (Sample No. 32 according to [Example 7]) with a scanning electron microscope after immersing the sample in a 1 M hydrochloric acid solution for 10 minutes.

FIG. 6 is an image obtained by observing the surface of Sample No. 13 according to [Example 2] (Sample No. 33 according to [Example 7]) with a scanning electron microscope after immersing the sample in a 1 M hydrochloric acid solution for 10 minutes.

FIG. 7 is an image obtained by observing the surface of Sample No. 14 according to [Example 2] (Sample No. 34 according to [Example 7]) with a scanning electron microscope after immersing the sample in a 1 M hydrochloric acid solution for 10 minutes.

FIG. 8 is an image obtained by observing the surface of Sample No. 15 according to [Example 2] (Sample No. 35 according to [Example 7]) with a scanning electron microscope after immersing the sample in a 1 M hydrochloric acid solution for 10 minutes.

FIG. 9 is an image obtained by observing the surface of Sample No. 16 according to [Example 2] (Sample No. 36 according to [Example 7]) with a scanning electron microscope after immersing the sample in a 1 M hydrochloric acid solution for 10 minutes.

FIG. 10 is an image obtained by observing the surface of Sample No. 17 according to [Example 2] (Sample No. 37 according to [Example 7]) with a scanning electron microscope after immersing the sample in a 1 M hydrochloric acid solution for 10 minutes.

FIG. 11 is an image obtained by observing the surface of Sample No. 18 according to [Example 2] (Sample No. 38 according to [Example 7]) with a scanning electron microscope after immersing the sample in a 1 M hydrochloric acid solution for 10 minutes.

FIG. 12 is an image obtained by observing the surface of Sample No. 19 according to [Example 2] (Sample No. 39 according to [Example 7]) with a scanning electron microscope after immersing the sample in a 1 M hydrochloric acid solution for 10 minutes.

FIG. 13 is an image obtained by observing the surface of Sample No. 20 according to [Example 2] (Sample No. 40 according to [Example 7]) with a scanning electron microscope after immersing the sample in a 1 M hydrochloric acid solution for 10 minutes.

FIG. 14 is data for showing current efficiency curves for comparison of Sample No. 12 and Comparative Example according to [Example 4].

FIG. 15 is a photograph of the external appearance of a glass sheet in the case where Sample No. 39 according to [Example 8] is re-melted, followed by processing into a glass sheet measuring about 10 mm×30 mm×1.0 mm in thickness and mirror polishing of both surfaces thereof without heat treatment.

FIG. 16 is a photograph of the external appearance of a glass sheet in the case where Sample No. 39 according to [Example 8] is re-melted, followed by heat treatment at 840° C. for 20 minutes and then processing into a glass sheet measuring about 10 mm×30 mm×1.0 mm in thickness and mirror polishing of both surfaces thereof.

FIG. 17 is a photograph of the external appearance of a glass sheet in the case where Sample No. 39 according to [Example 8] is re-melted, followed by heat treatment at 840° C. for 40 minutes and then processing into a glass sheet measuring about 10 mm×30 mm×1.0 mm in thickness and mirror polishing of both surfaces thereof.

### DESCRIPTION OF EMBODIMENTS

A glass of the present invention (first invention) has a phase separation structure comprising at least a first phase and a second phase, and the content of SiO₂ in the first phase is higher than the content of SiO₂ in the second phase. In addition, the content of B₂O₃ in the second phase is higher than the content of B₂O₃ in the first phase. With this, the refractive indices of the first phase and the second phase easily differ from each other, and hence the light scattering function of the glass can be enhanced.

It is preferred that, in at least one of those phases (first phase and/or second phase), phase separated particles have an average particle diameter of from 0.1 μm to 5 μm. When the phase separated particles have an average particle diameter of less than 0.1 μm, light radiated from an OLED layer hardly scatters at an interface between the first phase and the second phase. In addition, the light shows various scattering intensities depending on its wavelength through Rayleigh scattering. As a result, the element configuration of a light emitting layer needs to be optimized at the time of production of a white light OLED. In contrast, when the phase separated particles have an average particle diameter of more than 5 μm, there is a risk in that a total light transmittance lowers owing to an excessively high scattering intensity.

The glass of the present invention (first invention) comprises as a glass composition, in terms of mass %, preferably 30% to 75% of SiO₂, 0.1% to 50% of B₂O₃, and 0% to 35% of Al₂O₃, particularly preferably more than 39% and 75% or less of SiO₂, 10% to 40% of B₂O₃, and 10% or more and less than 23% of Al₂O₃. With this, a phase separation property is enhanced, and the light scattering function is easily enhanced. The reasons why the components are limited as described above are described below. It should be noted that, in the following description of the content range of each of the components, the expression “%” refers to “mass o”.

The content of SiO₂ is preferably from 30% to 75%. When the content of SiO₂ is large, meltability and formability are liable to lower, and a refractive index is liable to lower. Thus, the upper limit range of the content of SiO₂ is suitably 75% or less, 70% or less, or 65% or less, particularly suitably 60% or less. On the other hand, when the content of SiO₂ is small, a glass network structure is not easily formed, resulting in difficulty in vitrification. In addition, the viscosity of the glass becomes too low, with the result that it is difficult for the glass to keep a high liquidus viscosity. Thus, the lower limit range of the content of SiO₂ is suitably 30% or more, 35% or more, 38% or more, or more than 39%, particularly suitably 40% or more.

The content of B₂O₃ is preferably from 0.1% to 50%. B₂O₃ is a component which enhances the phase separation property. However, when the content of B₂O₃ is too large, the glass composition loses its component balance, and devitrification resistance is liable to lower. Besides, acid resistance is liable to lower. Thus, the upper limit range of the content of B₂O₃ is suitably 50% or less, 40% or less, or 30% or less, particularly suitably 25% or less. The lower limit range thereof is suitably 0.1% or more, 0.5% or more, 1% or more, 4% or more, 7% or more, 10% or more, 12% or more, 14% or more, 16% or more, 18% or more, or 20% or more, particularly suitably 22% or more.

The content of Al₂O₃ is preferably from 0% to 35%. Al₂O₃ is a component which enhances the devitrification resistance. However, when the content of Al₂O₃ is too large, the phase separation property is liable to lower. Besides, the glass composition loses its component balance, and the devitrification resistance is liable to lower contrarily. In addition, the acid resistance is liable to lower. Thus, the upper limit range of the content of Al₂O₃ is suitably 35% or less, 30% or less, 25% or less, or less than 23%, particularly suitably 20% or less. The lower limit range thereof is suitably 0.1% or more, 3% or more, 5% or more, 8% or more, 10% or more, 12% or more, or 14% or more, particularly suitably 15% or more.

From the viewpoint of striking a balance between the devitrification resistance and the phase separation property, the content of SiO₂—Al₂O₃—B₂O₃ is preferably from −10% to 30% or from −5% to 25%, particularly preferably from 0% to 20%, the content of Al₂O₃+B₂O₃ is preferably from 25% to 50% or from 29% to 45%, particularly preferably from 32% to 40%, and the mass ratio SiO₂/(Al₂O₃+B₂O₃) is preferably from 0.7 to 2 or from 0.8 to 2, particularly preferably from 0.85 to 1.6. It should be noted that the “content of SiO₂—Al₂O₃—B₂O₃” refers to a value obtained by subtracting the content of Al₂O₃ and further the content of B₂O₃ from the content of SiO₂. The “content of Al₂O₃+B₂O₃” refers to the total content of Al₂O₃ and B₂O₃. The “mass ratio SiO₂/(Al₂O₃+B₂O₃)” refers to a value obtained by dividing the content of SiO₂ by the total content of Al₂O₃ and B₂O₃.

Other than the above-mentioned components, for example, the following components may be introduced.

The content of Li₂O is preferably from 0% to 30%. Li₂O is a component which enhances the phase separation property. However, when the content of Li₂O is too large, the liquidus viscosity is liable to lower. In addition, a strain point is liable to lower. Further, an alkali component is liable to be eluted in an etching step with an acid. Thus, the upper limit range of the content of Li₂O is suitably 30% or less, 20% or less, 10% or less, 5% or less, or 1% or less, particularly suitably 0.5% or less.

The content of Na₂O is preferably from 0% to 30%. Na₂O is a component which enhances the phase separation property. However, when the content of Na₂O is too large, the liquidus viscosity is liable to lower. In addition, the strain point is liable to lower. Further, an alkali component is liable to be eluted in the etching step with an acid. Thus, the upper limit range of the content of Na₂O is suitably 30% or less, 20% or less, 10% or less, 5% or less, or 1% or less, particularly suitably 0.5% or less.

The content of K₂O is preferably from 0% to 30%. K₂O is a component which enhances the phase separation property. However, when the content of K₂O is too large, the liquidus viscosity is liable to lower. In addition, the strain point is liable to lower. Further, an alkali component is liable to be eluted in the etching step with an acid. Thus, the upper limit range of the content of K₂O is suitably 30% or less, 20% or less, 10% or less, 5% or less, or 1% or less, particularly suitably 0.5% or less.

The content of MgO is preferably from 0% to 30%. MgO is a component which increases the refractive index, a Young's modulus, and the strain point and is a component which lowers a viscosity at high temperature. However, when MgO is incorporated in a large amount, a liquidus temperature rises, with the result that the devitrification resistance may lower, and a density may become too high. Thus, the upper limit range of the content of MgO is suitably 30% or less, 20% or less, particularly suitably 10% or less, and the lower limit range thereof is suitably 0.1% or more, 1% or more, or 3% or more, particularly suitably 5% or more.

The content of CaO is preferably from 0% to 30%. CaO is a component which lowers the viscosity at high temperature. However, when the content of CaO is large, the density is liable to increase, and the glass composition loses its component balance, with the result that the devitrification resistance is liable to lower. Thus, the upper limit range of the content of CaO is suitably 30% or less, 20% or less, 10% or less, or 5% or less, particularly suitably 3% or less, and the lower limit range thereof is suitably 0.1% or more or 0.5% or more, particularly suitably 1% or more.

The content of SrO is preferably from 0% to 30%. When the content of SrO is large, the refractive index and the density are liable to increase, and the glass composition loses its component balance, with the result that the devitrification resistance is liable to lower. Thus, the upper limit range of the content of SrO is suitably 30% or less or 20% or less, particularly suitably 10% or less, and the lower limit range thereof is suitably 1% or more or 3% or more, particularly suitably 5% or more.

Among alkaline-earth metal oxides, BaO is a component which increases the refractive index of glass without reducing its viscosity extremely. When the content of BaO is large, the refractive index and the density are liable to increase, and the glass composition loses its components balance, with the result that the devitrification resistance is liable to lower. Thus, the upper limit range of the content of BaO is suitably 40% or less, 30% or less, 20% or less, or 10% or less, particularly suitably 5% or less, and the lower limit range thereof is suitably 0.1% or more, particularly suitably 1% or more.

ZnO is a component which increases the refractive index and the strain point, and is also a component which lowers the viscosity at high temperature. However, when ZnO is introduced in a large amount, the liquidus temperature increases, and the devitrification resistance is liable to lower. Thus, the upper limit range of the content of ZnO is suitably 20% or less, 10% or less, or 5% or less, particularly suitably 3% or less. The lower limit range thereof is suitably 0.1% or more, particularly suitably 1% or more.

TiO₂ is a component which increases the refractive index, and the content of TiO₂ is preferably from 0% to 20%. However, when the content of TiO₂ is large, the glass composition loses its component balance, and the devitrification resistance is liable to lower. In addition, there is a risk in that the total light transmittance lowers. Thus, the upper limit range of the content of TiO₂ is suitably 20% or less or 10% or less, particularly suitably 5% or less. The lower limit range thereof is suitably 0.001% or more, 0.01% or more, 0.1% or more, 1% or more, or 2% or more, particularly suitably 3% or more.

ZrO₂ is a component which increases the refractive index, and the content of ZrO₂ is preferably from 0% to 20%. However, when the content of ZrO₂ is large, the glass composition loses its component balance, and the devitrification resistance is liable to lower. Thus, the upper limit range of the content of ZrO₂ is suitably 20% or less or 10% or less, particularly suitably 5% or less. The lower limit range thereof is suitably 0.001% or more, 0.01% or more, 0.1% or more, 1% or more, or 2% or more, particularly suitably 3% or more.

La₂O₃ is a component which increases the refractive index, and the content of La₂O₃ is preferably from 0% to 10%. When the content of La₂O₃ is large, the density is liable to increase. In addition, the devitrification resistance and the acid resistance are liable to lower. Further, raw material cost increases, which is liable to cause a rise in the production cost of a glass sheet. Thus, the upper limit range of the content of La₂O₃ is suitably 10% or less, 5% or less, 3% or less, 2.5% or less, or 1% or less, particularly suitably 0.1% or less.

Nb₂O₅ is a component which increases the refractive index, and the content of Nb₂O₅ is preferably from 0% to 10%. When the content of Nb₂O₅ is large, the density is liable to increase. In addition, the devitrification resistance is liable to lower. Further, the raw material cost increases, which is liable to cause a rise in the production cost of the glass sheet. Thus, the upper limit range of the content of Nb₂O₅ is suitably 10% or less, 5% or less, 3% or less, 2.5% or less, or 1% or less, particularly suitably 0.1% or less.

Gd₂O₃ is a component which increases the refractive index, and the content of Gd₂O₃ is preferably from 0% to 10%. When the content of Gd₂O₃ is large, the density increases excessively, the devitrification resistance lowers owing to the glass composition losing its component balance, and it becomes difficult to ensure a high liquidus viscosity owing to an excessively low viscosity at high temperature. Thus, the upper limit range of the content of Gd₂O₃ is suitably 10% or less, 5% or less, 3% or less, 2.5% or less, or 1% or less, particularly suitably 0.1% or less.

The content of La₂O₃+Nb₂O₅ is preferably from 0% to 10%. When the content of La₂O₃+Nb₂O₅ is large, the density and a thermal expansion coefficient are liable to increase. In addition, the devitrification resistance is liable to lower, and further, it becomes difficult to ensure a high liquidus viscosity. Further, the raw material cost increases, which is liable to cause a rise in the production cost of the glass sheet. Thus, the upper limit range of the content of La₂O₃+Nb₂O₅ is suitably 10% or less, 8% or less, 5% or less, 3% or less, 1% or less, or 0.5% or less, particularly suitably 0.1% or less. Herein, the “content of La₂O₃+Nb₂O₅” refers to the total content of La₂O₃ and Nb₂O₅.

The content of a rare metal oxide is preferably from 0% to 10% in total. When the content of the rare metal oxide is large, the density and the thermal expansion coefficient are liable to increase. In addition, the devitrification resistance and the acid resistance are liable to lower, and it becomes difficult to ensure a high liquidus viscosity. Further, the raw material cost increases, which is liable to cause a rise in the production cost of the glass sheet. Thus, the upper limit range of the content of the rare metal oxide is suitably 10% or less, 5% or less, or 3% or less, particularly suitably 1% or less. It is desired that the glass be substantially free of the rare metal oxide.

As a fining agent, there may be introduced, in terms of oxides described below, 0% to 3% of one kind or two or more kinds selected from the group consisting of As₂O₃, Sb₂O₃, SnO₂, Fe₂O₃, F, Cl, SO₃, and CeO₂. SnO₂, Fe₂O₃, and CeO₂ are particularly preferred as the fining agent. On the other hand, As₂O₃ and Sb₂O₃ are preferably used in an amount as small as possible from the environmental viewpoint, and the contents thereof are each preferably less than 0.3%, particularly preferably less than 0.1%. Herein, the “in terms of oxides described below” means that even an oxide having a valence different from the valence of an explicit oxide is included through its conversion to any of the above-mentioned oxides.

The content of SnO₂ is preferably from 0% to 1% or from 0.001% to 1%, particularly preferably from 0.01% to 0.5%.

The upper limit range of the content of Fe₂O₃ is suitably 0.05% or less, 0.04% or less, or 0.03% or less, particularly suitably 0.02% or less. The lower limit range thereof is suitably 0.001% or more.

The content of CeO₂ is preferably from 0% to 6%. When the content of CeO₂ is large, the denitrification resistance is liable to lower. Thus, the upper limit range of the content of CeO₂ is suitably 6% or less, 5% or less, 3% or less, 2% or less, or 1% or less, particularly suitably 0.1% or less. On the other hand, when the content of CeO₂ is small, a fining property is liable to lower. Thus, in the case where CeO₂ is introduced, the lower limit range of the content of CeO₂ is suitably 0.001% or more, particularly suitably 0.01% or more.

PbO is a component which lowers the viscosity at high temperature, but is preferably used in an amount as small as possible from the environmental viewpoint. The content of PbO is preferably 0.5% or less, and it is desired that the glass be substantially free of PbO. Herein, the “substantially free of PbO” refers to the case where the content of PbO in the glass composition is less than 0.1%.

Components other than the above-mentioned components may be introduced at a total content of preferably up to 10% (desirably up to 5%).

In the glass of the present invention (first invention), the refractive index n_{d} is preferably more than 1.50, 1.51 or more, 1.52 or more, 1.53 or more, 1.54 or more, 1.55 or more, or 1.56 or more, particularly preferably 1.57 or more. When the refractive index n_{d} is 1.50 or less, it becomes difficult to extract light efficiently owing to reflection at an interface between the glass sheet and a transparent conductive film or the like. On the other hand, when the refractive index n_{d} is too high, it becomes difficult to extract light to the outside owing to a high reflectance at an interface between the glass sheet and air. Thus, the refractive index n_{d} is preferably 2.30 or less, 2.20 or less, 2.10 or less, 2.00 or less, 1.90 or less, or 1.80 or less, particularly preferably 1.75 or less.

The density is preferably 5.0 g/cm³ or less, 4.5 g/cm³ or less, or 3.0 g/cm³ or less, particularly preferably 2.8 g/cm³ or less. With this, the weight of a device can be reduced.

The strain point is preferably 450° C. or more or 500° C. or more, particularly preferably 550° C. or more. As the transparent conductive film is formed at a higher temperature, the transparent conductive film has higher transparency and lower electric resistance. However, a related-art glass sheet had insufficient heat resistance, and hence it was difficult to form the transparent conductive film at high temperature. Under such circumstance, when the strain point is set to fall within the above-mentioned range, it is possible to strike a balance between high transparency and low electric resistance of the transparent conductive film. Further, in production steps of the device, the glass sheet is less liable to undergo thermal shrinkage through heat treatment.

The temperature at 10^{2.5} dPa·s is preferably 1,600° C. or less, 1,560° C. or less, or 1,500° C. or less, particularly preferably 1,450° C. or less. With this, the meltability is enhanced, and hence the productivity of the glass sheet is enhanced.

The liquidus temperature is preferably 1,300° C. or less, 1,250° C. or less, or 1,200° C. or less, particularly preferably 1,150° C. or less. In addition, the liquidus viscosity is preferably 10^{2.5} dPa·s or more, 10^{3.0} dPa·s or more, 10^{3.5} dPa·s or more, 10^{3.8} dPa·s or more, 10^{4.0} dPa·s or more, or 10^{4.4} dPa·s or more, particularly preferably 10^{4.6} dPa·s or more. With this, the glass is less liable to be devitrified during its forming, and the glass sheet is easily formed by, for example, a float method or an overflow down-draw method. Herein, the “liquidus temperature” refers to a value obtained by measuring a temperature at which crystals of glass deposit when crushed glass powder which has passed through a standard 30-mesh sieve (sieve opening: 500 μm) and remained on a 50-mesh sieve (sieve opening: 300 μm) is placed in a platinum boat and kept in a gradient heating furnace for 24 hours. In addition, the “liquidus viscosity” refers to a viscosity of the glass at its liquidus temperature.

A phase separation temperature is preferably 800° C. or more, particularly preferably 900° C. or more. In addition, a phase separation viscosity is preferably 10^{7.0} dPa·s or less, particularly preferably from 10^{3.0} dPa·s to 10^{6.0} dPa·s. With this, the glass is easily phase separated in a forming step and/or an annealing step, and a glass sheet having the phase separation structure is easily formed by a float method or an overflow down-draw method. This eliminates the need for an additional heat treatment step after the forming of the glass sheet, and hence the production cost of the glass sheet is easily reduced.

The total light transmittance at a wavelength of 435 nm is preferably 5% or more or 10% or more, particularly preferably from 30% to 100%. With this, light extraction efficiency can be enhanced when an OLED element is fabricated.

The total light transmittance at a wavelength of 546 nm is preferably 5% or more, 10% or more, or 30% or more, particularly preferably from 50% to 100%. With this, the light extraction efficiency can be enhanced when the OLED element is fabricated.

The total light transmittance at a wavelength of 700 nm is preferably 5% or more, 10% or more, 30% or more, or 50% or more, particularly preferably from 70% to 100%. With this, the light extraction efficiency can be enhanced when the OLED element is fabricated.

The diffuse transmittance at a wavelength of 435 nm is preferably 5% or more, particularly preferably from 10% to 100%. With this, the light extraction efficiency can be enhanced when the OLED element is fabricated.

The diffuse transmittance at a wavelength of 546 nm is preferably 5% or more or 10% or more, particularly preferably from 20% to 100%. With this, the light extraction efficiency can be enhanced when the OLED element is fabricated.

The diffuse transmittance at a wavelength of 700 nm is preferably 1% or more or 5% or more, particularly preferably from 10% to 100%. With this, the light extraction efficiency can be enhanced when the OLED element is fabricated.

The haze value at a wavelength of 435 nm is preferably 5% or more, 10% or more, 30% or more, or 50% or more, particularly preferably from 70% to 100%. With this, the light extraction efficiency can be enhanced when the OLED element is fabricated. It should be noted that the “haze value” refers to a value calculated by the expression (diffuse transmittance)/(total light transmittance)×100.

The haze value at a wavelength of 546 nm is preferably 5% or more, 10% or more, 30% or more, or 50% or more, particularly preferably from 70% to 100%. With this, the light extraction efficiency can be enhanced when the OLED element is fabricated.

The haze value at a wavelength of 700 nm is preferably 1% or more or 5% or more, particularly preferably from 10% to 100%. With this, the light extraction efficiency can be enhanced when the OLED element is fabricated.

The total light transmittance at each wavelength of 435 nm, 546 nm, and 700 nm is preferably 1% or more or 3% or more, particularly preferably from 10% to 100%. With this, the light extraction efficiency can be enhanced when the OLED element is fabricated.

The diffuse transmittance at each wavelength of 435 nm, 546 nm, and 700 nm is preferably 1% or more or 3% or more, particularly preferably from 10% to 100%. With this, the light extraction efficiency can be enhanced when the OLED element is fabricated.

The haze value at each wavelength of 435 nm, 546 nm, and 700 nm is preferably 1% or more or 3% or more, particularly preferably from 10% to 100%. With this, the light extraction efficiency can be enhanced when the OLED element is fabricated.

The glass of the present invention (first invention) has a thickness (sheet thickness in the case of having a flat sheet shape) of preferably 1.5 mm or less, 1.3 mm or less, 1.1 mm or less, 0.8 mm or less, 0.6 mm or less, 0.5 mm or less, 0.3 mm or less, or 0.2 mm or less, particularly preferably 0.1 mm or less. As the glass has a smaller sheet thickness, its flexibility is increased more and an OLED illumination device having an excellent design property is produced more easily. However, when the glass has an excessively small sheet thickness, the glass is liable to be broken. Thus, the sheet thickness is preferably 10 μm or more, particularly preferably 30 μm or more.

The glass of the present invention (first invention) preferably has a flat sheet shape. That is, the glass is preferably a glass sheet. With this, the glass is easily applied to an OLED device. When the glass has a flat sheet shape, the glass preferably has an unpolished surface as at least one surface thereof (particularly preferably has an entirely unpolished effective surface as the effective surface in at least one surface thereof). The theoretical strength of the glass is very high. However, the glass often breaks even by a stress far lower than the theoretical strength. This is because small defects called Griffith flaws are produced in the surfaces of the glass in a step after the forming, such as a polishing step. Thus, when a surface of the glass sheet is not polished, the mechanical strength that the glass intrinsically has is not easily impaired, and hence the glass sheet does not easily break. In addition, the production cost of the glass sheet can be reduced, because the polishing step can be simplified or eliminated.

In the case where the glass has a flat sheet shape, its surface roughness Ra on at least one surface thereof (in particular, the unpolished surface) is preferably from 0.01 μm to 1 μm. When the surface roughness Ra is more than 1 μm, the quality of the transparent conductive film or the like formed on the surface lowers, and it becomes difficult to achieve uniform light emission. The upper limit range of the surface roughness Ra is suitably 1 μm or less, 0.8 μm or less, 0.5 μm or less, 0.3 μm or less, 0.1 μm or less, 0.07 μm or less, 0.05 μm or less, or 0.03 μm or less, particularly suitably 10 nm or less.

The glass of the present invention (first invention) is formed preferably by a down-draw method, particularly preferably by an overflow down-draw method. With this, an unpolished glass sheet having good surface quality can be produced. This is because, when the glass sheet is formed by the overflow down-draw method, the surfaces which are to serve as the surfaces of the glass sheet are formed in the state of a free surface without being brought into contact with a trough-shaped refractory. The structure and material of the trough-shaped structure are not particularly limited as long as desired dimensions and surface accuracy of the glass sheet can be achieved. Further, a method of applying a force to molten glass for down-drawing the molten glass downward is not particularly limited, either. For example, it is possible to adopt a method comprising rotating a heat-resistant roll having a sufficiently large width in the state of being in contact with molten glass, to thereby draw the molten glass, or a method comprising bringing a plurality of pairs of heat-resistant rolls into contact with only the vicinity of the edge surfaces of molten glass, to thereby draw the molten glass. It should be noted that it is possible to adopt a slot down-draw method, other than adopting the overflow down-draw method. With this, a glass sheet having a small thickness can be easily produced. Herein, the “slot down-draw method” refers to a method of forming a glass sheet by down-drawing molten glass downward while pouring the molten glass from apertures having a substantially rectangular shape.

A method other than the above-mentioned forming methods, such as a re-draw method, a float method, or a roll-out method, may also be adopted. In particular, a float method enables efficient production of a large-sized glass sheet.

In the case where the glass of the present invention (first invention) has a flat sheet shape, the glass may have a roughened surface as at least one surface thereof. When the roughened surface is arranged on a side in contact with air in an OLED illumination device or the like, light radiated from an OLED layer is less liable to return to the OLED layer by virtue of a non-reflective structure of the roughened surface in addition to a scattering effect of the glass sheet. As a result, the light extraction efficiency can be enhanced. The surface roughness Ra on the roughened surface is preferably 10 Å or more, 20 Å or more, or 30 Å or more, particularly preferably 50 Å or more. The roughened surface may be formed through HF etching, sandblasting, or the like. In addition, irregularities may be formed on the surface of the glass sheet through thermal processing, such as repressing. With this, the non-reflective structure is accurately formed on the surface of the glass sheet. The distance between the irregularities and the depth of each irregularity may be adjusted in consideration of the refractive index n_{d}.

In addition, the roughened surface may be formed by an atmospheric-pressure plasma process. With this, while the surface condition of one surface of the glass sheet is maintained, the other surface of the glass sheet can be uniformly subjected to roughening treatment. Further, it is preferred to use a gas containing F (such as SF₆ or CF₄) as a source for the atmospheric-pressure plasma process. With this, a plasma containing an HF-based gas is generated, and hence the roughened surface can be efficiently formed.

Further, it is also appropriate to form the roughened surface on at least one surface at the time of the forming of the glass sheet. This eliminates the need for separately independent roughening treatment, resulting in enhanced efficiency of the roughening treatment.

It should be noted that a resin film having predetermined irregularities may be bonded onto the surface of the glass sheet without forming the roughened surface on the glass sheet.

It is preferred that the glass of the present invention (first invention) be obtained without an additional heat treatment step. That is, it is preferred that the glass be phase separated in the forming step or the annealing (cooling) step immediately after the forming step. In particular, in the case where the glass sheet is formed by an overflow down-draw method, a phase separation phenomenon may occur in a trough-shaped structure or at the time of down-draw forming or annealing. With this, the number of production steps of the glass is reduced, resulting in enhanced productivity of the glass. It should be noted that the phase separation phenomenon may be controlled by the glass composition, forming conditions, annealing conditions, and the like.

It is preferred that the glass of the present invention (first invention) exhibit higher current efficiency than the current efficiency of a non-phase separated glass when incorporated into an OLED element. For example, at 10 mA/cm², the glass of the present invention exhibits higher current efficiency than the current efficiency of the non-phase separated glass by preferably 5% or more, 10% or more, 20% or more, or 30% or more, particularly preferably 40% or more. With this, the brightness of the OLED device can be increased.

It is preferred that the glass of the present invention (first invention) exhibit higher current efficiency than the current efficiency of a non-phase separated glass having a comparable refractive index n_{d} when incorporated into the OLED element. For example, at 10 mA/cm², the glass of the present invention exhibits higher current efficiency than the current efficiency of the non-phase separated glass having a comparable refractive index n_{d} by preferably 5% or more, 10% or more, 20% or more, or 30% or more, particularly preferably 40% or more. With this, the brightness of the OLED device can be increased. In particular, the brightness of the OLED device can be increased by merely introducing a component inducing the phase separation without significantly changing the existing glass composition.

A composite substrate of the present invention (first invention) comprises a glass sheet and a substrate bonded to each other, and the glass sheet is formed of the above-mentioned glass. With this, the glass sheet functions as a light scattering layer, and hence the light extraction efficiency of the OLED element can be enhanced by merely forming the glass sheet into a composite with the substrate. Further, when the glass sheet and the substrate are bonded to each other and the glass sheet is arranged on a side in contact with air, the scratch resistance of the composite substrate can be enhanced.

In the composite substrate of the present invention (first invention), the sheet thickness of the glass sheet is preferably 0.7 mm or less, 0.5 mm or less, 0.4 mm or less, 0.3 mm or less, or 0.2 mm or less, particularly preferably from 0.01 mm to 0.1 mm. With this, the total sheet thickness of the composite substrate can be reduced.

Various materials may be used as the substrate, and for example, a resin substrate, a metal substrate, or a glass substrate may be used. Of those, a glass substrate is preferred from the viewpoints of a transmitting property, weather resistance, and heat resistance. Various materials may be used as the glass substrate, and for example, a soda-lime glass substrate, an aluminosilicate glass substrate, or an alkali-free glass substrate may be used.

The thickness of the glass substrate is preferably from 0.3 mm to 3.0 mm or from 0.4 mm to 2.0 mm, particularly preferably more than 0.5 mm and 1.8 mm or less, from the viewpoint of maintaining strength.

The refractive index n_{d} of the glass substrate is preferably more than 1.50, 1.51 or more, 1.52 or more, or 1.53 or more, particularly preferably 1.54 or more. When the refractive index n_{d} of the glass substrate is too low, it becomes difficult to efficiently extract light owing to reflection at an interface between the glass substrate and the transparent conductive film or the like. On the other hand, when the refractive index n_{d} is too high, it becomes difficult to extract light in the glass substrate to air owing to a high reflectance at an interface between the glass substrate and the glass sheet. Therefore, the refractive index n_{d} is preferably 2.30 or less, 2.20 or less, 2.10 or less, 2.00 or less, 1.90 or less, or 1.80 or less, particularly preferably 1.75 or less.

The glass substrate preferably has a surface roughness Ra of from 0.01 μm to 1 μm on at least one surface thereof (in particular, an unpolished surface). When the surface roughness Ra on the surface is too large, the composite substrate is not easily produced through optical contact. Besides, the quality of the transparent conductive film or the like formed on the surface lowers, and it becomes difficult to achieve uniform light emission. Thus, the upper limit range of the surface roughness Ra on at least one surface is suitably 1 μm or less, 0.8 μm or less, 0.5 μm or less, 0.3 μm or less, 0.1 μm or less, 0.07 μm or less, 0.05 μm or less, or 0.03 μm or less, particularly suitably 10 nm or less.

Various methods may be utilized as a method of bonding the glass sheet and the substrate to each other. For example, a method involving bonding with an adhesive tape, an adhesive sheet, an adhesive, a curing agent, or the like, or a method involving bonding through optical contact may be utilized. Of those, a method involving bonding through optical contact is preferred from the viewpoint of increasing the transmittance of the composite substrate.

A method of producing a glass of the present invention (second invention) comprises performing heat treatment, to thereby obtain a glass having a phase separation structure comprising at least a first phase and a second phase. It is preferred that the content of SiO₂ in the first phase be higher than the content of SiO₂ in the second phase, and the content of B₂O₃ in the second phase be higher than the content of B₂O₃ in the first phase. With this, the refractive indices of the first phase and the second phase easily differ from each other, and hence the light scattering function of the glass can be enhanced.

In the method of producing a glass of the present invention (second invention), the heat treatment temperature after the forming of molten glass is preferably 600° C. or more, 700° C. or more, or 750° C. or more, particularly preferably 800° C. or more. With this, a phase separation property can be enhanced. On the other hand, the heat treatment temperature is preferably 1,100° C. or less, particularly preferably 1,000° C. or less. When the heat treatment temperature is too high, the cost of the heat treatment increases. Besides, there is a risk in that a linear transmittance, a total light transmittance, and the like may lower owing to an excessively high scattering intensity.

In the method of producing a glass of the present invention (second invention), the time period of the heat treatment is preferably 1 minute or more, particularly preferably 5 minutes or more. With this, the phase separation property can be enhanced. On the other hand, the time period of the heat treatment is preferably 60 minutes or less, particularly preferably 40 minutes or less. When the time period of the heat treatment is too long, the cost of the heat treatment increases. Besides, there is a risk in that the linear transmittance, the total light transmittance, and the like may lower owing to an excessively high scattering intensity.

In the method of producing a glass of the present invention (second invention), the glass preferably comprises as a glass composition, in terms of mass %, 30% to 75% of SiO₂, 0.1% to 50% of B₂O₃, and 0% to 35% of Al₂O₃. With this, the phase separation property is enhanced, and the light scattering function is easily enhanced. The reasons why the components are limited as described above are described below. It should be noted that, in the following description of the content range of each of the components, the expression “%” refers to “mass %”.

The content of SiO₂ is preferably from 30% to 75%. When the content of SiO₂ is large, meltability and formability are liable to lower, and a refractive index is liable to lower. Thus, the upper limit range of the content of SiO₂ is suitably 75% or less, 70% or less, or 65% or less, particularly suitably 60% or less. On the other hand, when the content of SiO₂ is small, a glass network structure is not easily formed, resulting in difficulty in vitrification. In addition, the viscosity of the glass becomes too low, with the result that it is difficult for the glass to keep a high liquidus viscosity. Thus, the lower limit range of the content of SiO₂ is suitably 30% or more or 35% or more, particularly suitably 38% or more.

The content of B₂O₃ is preferably from 0.1% to 50%. B₂O₃ is a component which enhances the phase separation property. However, when the content of B₂O₃ is too large, the glass composition loses its component balance, and devitrification resistance is liable to lower. Besides, acid resistance is liable to lower. Thus, the upper limit range of the content of B₂O₃ is suitably 50% or less, 40% or less, or 30% or less, particularly suitably 25% or less. The lower limit range thereof is suitably 0.1% or more, 0.5% or more, 1% or more, 4% or more, or 7% or more, particularly suitably 10% or more.

The content of Al₂O₃ is preferably from 0% to 35%. Al₂O₃ is a component which enhances the devitrification resistance. However, when the content of Al₂O₃ is too large, the phase separation property is liable to lower. Besides, the glass composition loses its component balance, and the devitrification resistance is liable to lower contrarily. In addition, the acid resistance is liable to lower. Thus, the upper limit range of the content of Al₂O₃ is suitably 35% or less, 30% or less, or 25% or less, particularly suitably 20% or less. The lower limit range thereof is suitably 0.1% or more, 3% or more, 5% or more, or 8% or more, particularly suitably 10% or more.

Other than the above-mentioned components, for example, the following components may be introduced.

The content of Li₂O is preferably from 0% to 30%. Li₂O is a component which enhances the phase separation property. However, when the content of Li₂O is too large, the liquidus viscosity is liable to lower. In addition, a strain point is liable to lower. Further, an alkali component is liable to be eluted in an etching step with an acid. Thus, the upper limit range of the content of Li₂O is suitably 30% or less, 20% or less, 10% or less, 5% or less, or 1% or less, particularly suitably 0.5% or less.

The content of Na₂O is preferably from 0% to 30%. Na₂O is a component which enhances the phase separation property. However, when the content of Na₂O is too large, the liquidus viscosity is liable to lower. In addition, the strain point is liable to lower. Further, an alkali component is liable to be eluted in the etching step with an acid. Thus, the upper limit range of the content of Na₂O is suitably 30% or less, 20% or less, 10% or less, 5% or less, or 1% or less, particularly suitably 0.5% or less.

The content of K₂O is preferably from 0% to 30%. K₂O is a component which enhances the phase separation property. However, when the content of K₂O is too large, the liquidus viscosity is liable to lower. In addition, the strain point is liable to lower. Further, an alkali component is liable to be eluted in the etching step with an acid. Thus, the upper limit range of the content of K₂O is suitably 30% or less, 20% or less, 10% or less, 5% or less, or 1% or less, particularly suitably 0.5% or less.

The content of MgO is preferably from 0% to 30%. MgO is a component which increases the refractive index, a Young's modulus, and the strain point and is a component which lowers a viscosity at high temperature. However, when MgO is incorporated in a large amount, a liquidus temperature rises, with the result that the devitrification resistance may lower, and a density may become too high. Thus, the upper limit range of the content of MgO is suitably 30% or less, 20% or less, particularly suitably 10% or less, and the lower limit range thereof is suitably 0.1% or more, 1% or more, or 3% or more, particularly suitably 5% or more.

The content of CaO is preferably from 0% to 30%. CaO is a component which lowers the viscosity at high temperature. However, when the content of CaO is large, the density is liable to increase, and the glass composition loses its component balance, with the result that the devitrification resistance is liable to lower. Thus, the upper limit range of the content of CaO is suitably 30% or less, 20% or less, 10% or less, or 5% or less, particularly suitably 3% or less, and the lower limit range thereof is suitably 0.1% or more or 0.5% or more, particularly suitably 1% or more.

The content of SrO is from 0% to 30%. When the content of SrO is large, the refractive index and the density are liable to increase, and the glass composition loses its component balance, with the result that the devitrification resistance is liable to lower. Thus, the upper limit range of the content of SrO is suitably 30% or less or 20% or less, particularly suitably 10% or less, and the lower limit range thereof is suitably 1% or more or 3% or more, particularly suitably 5% or more.

Among alkaline-earth metal oxides, BaO is a component which increases the refractive index of glass without reducing its viscosity extremely. When the content of BaO is large, the refractive index and the density are liable to increase, and the glass composition loses its component balance, with the result that the devitrification resistance is liable to lower. Thus, the upper limit range of the content of BaO is suitably 40% or less, 30% or less, 20% or less, or 10% or less, particularly suitably 5% or less, and the lower limit range thereof is suitably 0.1% or more, particularly suitably 1% or more.

ZnO is a component which increases the refractive index and the strain point, and is also a component which lowers the viscosity at high temperature. However, when ZnO is introduced in a large amount, the liquidus temperature increases, and the devitrification resistance lowers. Thus, the upper limit range of the content of ZnO is suitably 20% or less, 10% or less, or 5% or less, particularly suitably 3% or less. The lower limit range thereof is suitably 0.1% or more, particularly suitably 1% or more.

TiO₂ is a component which increases the refractive index, and the content of TiO₂ is preferably from 0% to 20%. However, when the content of TiO₂ is large, the glass composition loses its component balance, and the devitrification resistance is liable to lower. In addition, there is a risk in that the total light transmittance lowers. Thus, the upper limit range of the content of TiO₂ is suitably 20% or less, particularly suitably 10% or less. The lower limit range thereof is suitably 0.001% or more, 0.01% or more, 0.1% or more, 1% or more, or 2% or more, particularly suitably 3% or more.

ZrO₂ is a component which increases the refractive index, and the content of ZrO₂ is preferably from 0% to 20%. However, when the content of ZrO₂ is large, the glass composition loses its component balance, and the devitrification resistance is liable to lower. Thus, the upper limit range of the content of ZrO₂ is suitably 20% or less or 10% or less, particularly suitably 5% or less. The lower limit range thereof is suitably 0.001% or more, 0.01% or more, 0.1% or more, 1% or more, or 2% or more, particularly suitably 3% or more.

La₂O₃ is a component which increases the refractive index, and the content of La₂O₃ is preferably from 0% to 10%. When the content of La₂O₃ is large, the density is liable to increase. In addition, the devitrification resistance and the acid resistance are liable to lower. Further, raw material cost increases, which is liable to cause a rise in the production cost of a glass sheet. Thus, the upper limit range of the content of La₂O₃ is suitably 10% or less, 5% or less, 3% or less, 2.5% or less, or 1% or less, particularly suitably 0.1% or less.

Nb₂O₅ is a component which increases the refractive index, and the content of Nb₂O₅ is preferably from 0% to 10%. When the content of Nb₂O₅ is large, the density is liable to increase. In addition, the devitrification resistance is liable to lower. Further, the raw material cost increases, which is liable to cause a rise in the production cost of the glass sheet. Thus, the upper limit range of the content of Nb₂O₅ is suitably 10% or less, 5% or less, 3% or less, 2.5% or less, or 1% or less, particularly suitably 0.1% or less.

Gd₂O₃ is a component which increases the refractive index, and the content of Gd₂O₃ is preferably from 0% to 10%. When the content of Gd₂O₃ is large, the density increases excessively, the devitrification resistance lowers owing to the glass composition losing its component balance, and it becomes difficult to ensure a high liquidus viscosity owing to an excessively low viscosity at high temperature. Thus, the upper limit range of the content of Gd₂O₃ is suitably 10% or less, 5% or less, 3% or less, 2.5% or less, or 1% or less, particularly suitably 0.1% or less.

The content of La₂O₃+Nb₂O₅ is preferably from 0% to 10%. When the content of La₂O₃+Nb₂O₅ is large, the density and a thermal expansion coefficient are liable to increase. In addition, the devitrification resistance is liable to lower, and further, it becomes difficult to ensure a high liquidus viscosity. Further, the raw material cost increases, which is liable to cause a rise in the production cost of the glass sheet. Thus, the upper limit range of La₂O₃+Nb₂O₅ is suitably 10% or less, 8% or less, 5% or less, 3% or less, 1% or less, or 0.5% or less, particularly suitably 0.1% or less. Herein, the “content of La₂O₃+Nb₂O₅” refers to the total content of La₂O₃ and Nb₂O₅.

The content of a rare metal oxide is preferably from 0% to 10% in total. When the content of the rare metal oxide is large, the density and the thermal expansion coefficient are liable to increase. In addition, the devitrification resistance and the acid resistance are liable to lower, and it becomes difficult to ensure a high liquidus viscosity. Further, the raw material cost increases, which is liable to cause a rise in the production cost of the glass sheet. Thus, the upper limit range of the content of the rare metal oxide is suitably 10% or less, 5% or less, or 3% or less, particularly suitably 1% or less. It is desired that the glass be substantially free of the rare metal oxide.

As a fining agent, there may be introduced, in terms of oxides described below, 0% to 3% of one kind or two or more kinds selected from the group consisting of As₂O₃, Sb₂O₃, SnO₂, Fe₂O₃, F, Cl, SO₃, and CeO₂. SnO₂, Fe₂O₃, and CeO₂ are particularly preferred as the fining agent. On the other hand, As₂O₃ and Sb₂O₃ are preferably used in an amount as small as possible from the environmental viewpoint, and the contents thereof are each preferably less than 0.3%, particularly preferably less than 0.1%. Herein, the “in terms of oxides described below” means that even an oxide having a valence different from the valence of an explicit oxide is included through its conversion to any of the above-mentioned oxides.

The content of SnO₂ is preferably from 0% to 1% or from 0.001% to 1%, particularly preferably from 0.01% to 0.5%.

The upper limit range of the content of Fe₂O₃ is suitably 0.05% or less, 0.04% or less, or 0.03% or less, particularly suitably 0.02% or less. The lower limit range thereof is suitably 0.001% or more.

The content of CeO₂ is preferably from 0% to 6%. When the content of CeO₂ is large, the denitrification resistance is liable to lower. Thus, the upper limit range of the content of CeO₂ is suitably 6% or less, 5% or less, 3% or less, 2% or less, or 1% or less, particularly suitably 0.1% or less. On the other hand, when the content of CeO₂ is small, a fining property is liable to lower. Thus, in the case where CeO₂ is introduced, the lower limit range of the content of CeO₂ is suitably 0.001% or more, particularly suitably 0.01% or more.

PbO is a component which lowers the viscosity at high temperature, but is preferably used in an amount as small as possible from the environmental viewpoint. The content of PbO is preferably 0.5% or less, and it is desired that the glass be substantially free of PbO. Herein, the “substantially free of PbO” refers to the case where the content of PbO in the glass composition is less than 0.1%.

Components other than the above-mentioned components may be introduced at a total content of preferably up to 10% (desirably up to 50).

The glass according to the present invention (second invention) preferably has the following characteristics.

The glass according to the present invention has a refractive index n_{d} of preferably more than 1.50, 1.51 or more, 1.52 or more, 1.53 or more, 1.54 or more, 1.55 or more, or 1.555 or more, particularly preferably 1.565 or more. When the refractive index n_{d} is 1.50 or less, light cannot be extracted efficiently owing to reflectance at an interface between the glass sheet and a transparent conductive film or the like. On the other hand, when the refractive index n_{d} is too high, it becomes difficult to extract light to the outside owing to a high reflectance at an interface between the glass sheet and air. Thus, the refractive index n_{d} is preferably 2.30 or less, 2.20 or less, 2.10 or less, 2.00 or less, 1.90 or less, or 1.80 or less, particularly preferably 1.75 or less.

The density is preferably 5.0 g/cm³ or less, 4.5 g/cm³ or less, or 3.0 g/cm³ or less, particularly preferably 2.8 g/cm³ or less. With this, the weight of a device can be reduced.

The strain point is preferably 450° C. or more or 500° C. or more, particularly preferably 550° C. or more. As the transparent conductive film is formed at a higher temperature, the transparent conductive film has higher transparency and lower electric resistance. However, a related-art glass sheet had insufficient heat resistance, and hence it was difficult to form the transparent conductive film at high temperature. Under such circumstance, when the strain point is set to fall within the above-mentioned range, it is possible to strike a balance between high transparency and low electric resistance of the transparent conductive film. Further, in production steps of the device, the glass sheet is less liable to undergo thermal shrinkage through heat treatment.

The temperature at 10^{2.5} dPa·s is preferably 1,600° C. or less, 1,560° C. or less, or 1,500° C. or less, particularly preferably 1,450° C. or less. With this, the meltability is enhanced, and hence the productivity of the glass sheet is enhanced.

The liquidus temperature is preferably 1,300° C. or less, 1,250° C. or less, or 1,200° C. or less, particularly preferably 1,150° C. or less. In addition, the liquidus viscosity is preferably 10^{2.5} dPa·s or more, 10^{3.0} dPa·s or more, 10^{3.5} dPa·s or more, 10^{3.8} dPa·s or more, 10^{4.0} dPa·s or more, or 10^{4.4} dPa·s or more, particularly preferably 10^{4.6} dPa·s or more. With this, the glass is less liable to be devitrified during its forming, and the glass sheet is easily formed by, for example, a float method or an overflow down-draw method. Herein, the “liquidus temperature” refers to a value obtained by measuring a temperature at which crystals of glass deposit when crushed glass powder which has passed through a standard 30-mesh sieve (sieve opening: 500 μm) and remained on a 50-mesh sieve (sieve opening: 300 μm) is placed in a platinum boat and kept in a gradient heating furnace for 24 hours. In addition, the “liquidus viscosity” refers to a viscosity of the glass at its liquidus temperature.

In the method of producing a glass of the present invention (second invention), the resultant glass has a thickness (sheet thickness in the case of having a flat sheet shape) controlled to preferably 1.5 mm or less, 1.3 mm or less, 1.1 mm or less, 0.8 mm or less, 0.6 mm or less, 0.5 mm or less, 0.3 mm or less, or 0.2 mm or less, particularly preferably 0.1 mm or less. As the glass has a smaller sheet thickness, its flexibility is increased more and an OLED illumination device having an excellent design property is produced more easily. However, when the glass has an excessively small sheet thickness, the glass is liable to be broken. Thus, the sheet thickness is preferably 10 μm or more, particularly preferably 30 μm or more.

In the method of producing a glass of the present invention (second invention), the glass is preferably formed into a flat sheet shape. That is, the glass is preferably formed into a glass sheet. With this, the resultant glass is easily applied to an OLED device. After the glass is formed into a flat sheet shape, the glass sheet preferably has an unpolished surface as at least one surface thereof (particular preferably has an entirely unpolished effective surface as the effective surface in at least one surface thereof). The theoretical strength of the glass is very high. However, the glass often breaks even by a stress far lower than the theoretical strength. This is because small defects called Griffith flaws are produced in the surfaces of the glass in a step after the forming, such as a polishing step. Thus, when a surface of the glass sheet is not polished, the mechanical strength that the glass intrinsically has is not easily impaired, and hence the glass sheet does not easily break. In addition, the production cost of the glass sheet can be reduced, because the polishing step can be simplified or eliminated.

In the case where the glass is formed into a flat sheet shape, its surface roughness Ra on at least one surface thereof (in particular, the unpolished surface) is preferably controlled to from 0.01 μm to 1 μm. When the surface roughness Ra is more than 1 μm, the quality of the transparent conductive film or the like formed on the surface lowers, and it becomes difficult to achieve uniform light emission. The upper limit range of the surface roughness Ra is suitably 1 μm or less, 0.8 μm or less, 0.5 μm or less, 0.3 μm or less, 0.1 μm or less, 0.07 μm or less, 0.05 μm or less, or 0.03 μm or less, particularly suitably 10 nm or less.

In the method of producing a glass of the present invention (second invention), the glass is formed preferably by a down-draw method, particularly preferably by an overflow down-draw method. With this, an unpolished glass sheet having good surface quality can be produced. This is because, when the glass sheet is formed by the overflow down-draw method, the surfaces which are to serve as the surfaces of the glass sheet are formed in the state of a free surface without being brought into contact with a trough-shaped refractory. The structure and material of the trough-shaped structure are not particularly limited as long as desired dimensions and surface accuracy of the glass sheet can be achieved. Further, a method of applying a force to molten glass for down-drawing the molten glass downward is not particularly limited, either. For example, it is possible to adopt a method comprising rotating a heat-resistant roll having a sufficiently large width in the state of being in contact with molten glass, to thereby draw the molten glass, or a method comprising bringing a plurality of pairs of heat-resistant rolls into contact with only the vicinity of the edge surfaces of molten glass, to thereby draw the molten glass. It should be noted that it is possible to adopt a slot down-draw method, other than adopting the overflow down-draw method. With this, a glass sheet having a small thickness can be easily produced. Herein, the “slot down-draw method” refers to a method of forming a glass sheet by down-drawing molten glass downward while pouring the molten glass from apertures having a substantially rectangular shape.

A method other than the above-mentioned forming methods, such as a re-draw method, a float method, or a roll-out method, may also be adopted. In particular, a float method enables efficient production of a large-sized glass sheet.

In the method of producing a glass sheet of the present invention (second invention), after the glass is formed into a flat sheet shape, a roughened surface may be formed as at least one surface thereof. When the roughened surface is arranged on a side in contact with air in an OLED illumination device or the like, incident light from an OLED layer is less liable to return to the OLED layer by virtue of a non-reflective structure of the roughened surface in addition to a scattering effect of the glass sheet. As a result, the light extraction efficiency can be enhanced. The surface roughness Ra on the roughened surface is preferably 10 Å or more, 20 Å or more, or 30 Å or more, particularly preferably 50 Å or more. The roughened surface may be formed through HF etching, sandblasting, or the like. In addition, irregularities may be formed on the surface of the glass sheet through thermal processing, such as repressing. With this, the non-reflective structure is accurately formed on the surface of the glass sheet. The distance between the irregularities and the depth of each irregularity may be adjusted in consideration of the refractive index n_{d}.

In addition, the roughened surface may be formed by an atmospheric-pressure plasma process. With this, while the surface condition of one surface of the glass sheet is maintained, the other surface of the glass sheet can be uniformly subjected to the roughening treatment. Further, it is preferred to use a gas containing F (such as SF₆ or CF₄) as a source for the atmospheric-pressure plasma process. With this, a plasma containing an HF-based gas is generated, and hence the roughened surface can be efficiently formed.

Further, it is also appropriate to form the roughened surface on at least one surface at the time of the forming of the glass sheet. This eliminates the need for separately independent roughening treatment, resulting in enhanced efficiency of the roughening treatment.

It should be noted that a resin film having predetermined irregularities may be bonded onto the surface of the glass sheet instead of performing any of the above-mentioned methods.

A glass of the present invention (second invention) is produced by the method of producing a glass described above. Another glass of the present invention (second invention) is not yet phase separated, but has a property of being phase separated into at least a first phase and a second phase from a non-phase separated state through heat treatment, and is used for an OLED device. It should be noted that the technical features of those glasses of the present invention (preferred configurations and effects) have already been described in the description section of the method of producing a glass of the present invention, and hence detailed description of the technical features are omitted.

In the glasses of the present invention (second invention) before the heat treatment, the haze value at each wavelength of 435 nm, 546 nm, and 700 nm is preferably 80% or less or 70% or less, particularly preferably 50% or less, and preferably 0% or more or 1% or more, particularly preferably 3% or more. When the haze value before the heat treatment is adjusted as described above, a situation in which the glass is excessively phase separated in its forming and it becomes difficult to control its phase separation property is easily avoided. In addition, even in the case where the glass is phase separated in a forming step or an annealing (cooling) step immediately after the forming step, the additional heat treatment facilitates the production of a glass having desired scattering characteristics.

In the glasses of the present invention (second invention) after the heat treatment, the total light transmittance at a wavelength of 435 nm is preferably 5% or more, particularly preferably from 10% to 100%. Further, it is preferred that the glasses of the present invention each have a property of having a total light transmittance at a wavelength of 435 nm of 5% or more, particularly from 10% to 80% after subjected to heat treatment at 840° C. for 20 minutes. In addition, it is preferred that the glasses of the present invention each have a property of having a total light transmittance at a wavelength of 435 nm of 5% or more, particularly from 8% to 60% after subjected to heat treatment at 840° C. for 40 minutes. With this, light extraction efficiency can be enhanced when an OLED element is fabricated.

In the glasses of the present invention (second invention) after the heat treatment, the total light transmittance at a wavelength of 546 nm is preferably 5% or more, 10% or more, or 30% or more, particularly preferably from 50% to 100%. Further, it is preferred that the glasses of the present invention each have a property of having a total light transmittance at a wavelength of 546 nm of 5% or more, 10% or more, or 30% or more, particularly from 50% to 100% after subjected to heat treatment at 840° C. for 20 minutes. In addition, it is preferred that the glasses of the present invention each have a property of having a total light transmittance at a wavelength of 546 nm of 5% or more, 10% or more, or 20% or more, particularly from 30% to 80% after subjected to heat treatment at 840° C. for 40 minutes. With this, the light extraction efficiency can be enhanced when the OLED element is fabricated.

In the glasses of the present invention (second invention) after the heat treatment, the total light transmittance at a wavelength of 700 nm is preferably 5% or more, 10% or more, 30% or more, or 50% or more, particularly preferably from 70% to 100%. Further, it is preferred that the glasses of the present invention each have a property of having a total light transmittance at a wavelength of 700 nm of 5% or more, 10% or more, 30% or more, or 50% or more, particularly from 70% to 100% after subjected to heat treatment at 840° C. for 20 minutes. In addition, it is preferred that the glasses of the present invention each have a property of having a total light transmittance at a wavelength of 700 nm of 5% or more, 10% or more, 30% or more, or 50% or more, particularly from 60% to 100% after subjected to heat treatment at 840° C. for 40 minutes. With this, the light extraction efficiency can be enhanced when the OLED element is fabricated.

In the glasses of the present invention (second invention) after the heat treatment, the diffuse transmittance at a wavelength of 435 nm is preferably 5% or more, particularly preferably from 10% to 100%. Further, it is preferred that the glasses of the present invention each have a property of having a diffuse transmittance at a wavelength of 435 nm of 5% or more, particularly from 10% to 80% after subjected to heat treatment at 840° C. for 20 minutes. In addition, it is preferred that the glasses of the present invention each have a property of having a diffuse transmittance at a wavelength of 435 nm of 5% or more, particularly from 8% to 60% after subjected to heat treatment at 840° C. for 40 minutes. With this, the light extraction efficiency can be enhanced when the OLED element is fabricated.

In the glasses of the present invention (second invention) after the heat treatment, the diffuse transmittance at a wavelength of 546 nm is preferably 5% or more or 10% or more, particularly preferably from 20% to 100%. Further, it is preferred that the glasses of the present invention each have a property of having a diffuse transmittance at a wavelength of 546 nm of 5% or more or 10% or more, particularly from 15% to 80% after subjected to heat treatment at 840° C. for 20 minutes. In addition, the glasses of the present invention each have a diffuse transmittance at a wavelength of 546 nm of preferably 5% or more or 10% or more, particularly preferably from 20% to 90% after subjected to heat treatment at 840° C. for 40 minutes. With this, the light extraction efficiency can be enhanced when the OLED element is fabricated.

In the glasses of the present invention (second invention) after the heat treatment, the diffuse transmittance at a wavelength of 700 nm is preferably 1% or more or 5% or more, particularly preferably from 10% to 100%. Further, it is preferred that the glasses of the present invention each have a property of having a diffuse transmittance at a wavelength of 700 nm of 1% or more or 5% or more, particularly from 8% to 60% after subjected to heat treatment at 840° C. for 20 minutes. In addition, it is preferred that the glasses of the present invention each have a property of having a diffuse transmittance at a wavelength of 700 nm of 1% or more or 5% or more, particularly from 10% to 80% after subjected to heat treatment at 840° C. for 40 minutes. With this, the light extraction efficiency can be enhanced when the OLED element is fabricated.

In the glasses of the present invention (second invention) after the heat treatment, the haze value at a wavelength of 435 nm is preferably 5% or more, 10% or more, 30% or more, or 50% or more, particularly preferably from 70% to 100%. Further, it is preferred that the glasses of the present invention each have a property of having a haze value at a wavelength of 435 nm of 5% or more, 10% or more, 30% or more, or 50% or more, particularly from 70% to 100% after subjected to heat treatment at 840° C. for 20 minutes. In addition, it is preferred that the glasses of the present invention each have a property of having a haze value at a wavelength of 435 nm of 5% or more, 10% or more, 30% or more, or 50% or more, particularly from 70% to 100% after subjected to heat treatment at 840° C. for 40 minutes. With this, the light extraction efficiency can be enhanced when the OLED element is fabricated.

In the glasses of the present invention (second invention) after the heat treatment, the haze value at a wavelength of 546 nm is preferably 5% or more, 10% or more, 30% or more, or 50% or more, particularly preferably from 70% to 100%. Further, it is preferred that the glasses of the present invention each have a property of having a haze value at a wavelength of 546 nm of 5% or more, 10% or more, 30% or more, or 40% or more, particularly from 45% to 80% after subjected to heat treatment at 840° C. for 20 minutes. In addition, it is preferred that the glasses of the present invention each have a property of having a haze value at a wavelength of 546 nm of 5% or more, 10% or more, 30% or more, or 50% or more, particularly from 70% to 100% after subjected to heat treatment at 840° C. for 40 minutes. With this, the light extraction efficiency can be enhanced when the OLED element is fabricated.

In the glasses of the present invention (second invention) after the heat treatment, the haze value at a wavelength of 700 nm is preferably 1% or more or 5% or more, particularly preferably from 10% to 100%. Further, it is preferred that the glasses of the present invention each have a property of having a haze value at a wavelength of 700 nm of 1% or more or 5% or more, particularly from 8% to 60% after subjected to heat treatment at 840° C. for 20 minutes. In addition, it is preferred that the glasses of the present invention each have a property of having a haze value at a wavelength of 700 nm of 1% or more or 5% or more, particularly from 10% to 80% after subjected to heat treatment at 840° C. for 40 minutes. With this, the light extraction efficiency can be enhanced when the OLED element is fabricated.

In the glasses of the present invention (second invention) after the heat treatment, the total light transmittance at each wavelength of 435 nm, 546 nm, and 700 nm is preferably 1% or more or 3% or more, particularly preferably from 10% to 100%. Further, it is preferred that the glasses of the present invention each have a property of having a total light transmittance at each wavelength of 435 nm, 546 nm, and 700 nm of 1% or more, 3% or more, 5% or more, or 10% or more, particularly from 15% to 100% after subjected to heat treatment at 840° C. for 20 minutes. In addition, it is preferred that the glasses of the present invention each have a property of having a total light transmittance at each wavelength of 435 nm, 546 nm, and 700 nm of 1% or more, 3% or more, or 5% or more, particularly from 10% to 90% after subjected to heat treatment at 840° C. for 40 minutes. With this, the light extraction efficiency can be enhanced when the OLED element is fabricated.

In the glasses of the present invention (second invention) after the heat treatment, the diffuse transmittance at each wavelength of 435 nm, 546 nm, and 700 nm is preferably 1% or more or 3% or more, particularly preferably from 10% to 100%. Further, it is preferred that the glasses of the present invention each have a property of having a diffuse transmittance at each wavelength of 435 nm, 546 nm, and 700 nm of 1% or more or 3% or more, particularly from 5% to 60% after subjected to heat treatment at 840° C. for 20 minutes. In addition, it is preferred that the glasses of the present invention each have a property of having a diffuse transmittance at each wavelength of 435 nm, 546 nm, and 700 nm of 1% or more, 3% or more, or 5% or more, particularly from 10% to 80% after subjected to heat treatment at 840° C. for 40 minutes. With this, the light extraction efficiency can be enhanced when the OLED element is fabricated.

In the glasses of the present invention (second invention) after the heat treatment, the haze value at each wavelength of 435 nm, 546 nm, and 700 nm is preferably 1% or more, 3% or more, or 5% or more, particularly preferably from 10% to 100%. Further, it is preferred that the glasses of the present invention each have a property of having a haze value at each wavelength of 435 nm, 546 nm, and 700 nm of 1% or more, 3% or more, or 5% or more, particularly from 8% to 100% after subjected to heat treatment at 840° C. for 20 minutes. In addition, it is preferred that the glasses of the present invention each have a property of having a haze value at each wavelength of 435 nm, 546 nm, and 700 nm of 1% or more, 3% or more, or 5% or more, particularly from 10% to 100% after subjected to heat treatment at 840° C. for 40 minutes. With this, the light extraction efficiency can be enhanced when the OLED element is fabricated.

### EXAMPLES

### Example 1

Now, the present invention (first invention) is described in detail by way of Examples. It should be noted that the following Examples are merely illustrative. The present invention (first invention) is by no means limited to the Examples described below.

Sample Nos. 1 to 20 are shown in Tables 1 and 2.

TABLE 1

| (wt %) | No. 1 | No. 2 | No. 3 | No. 4 | No. 5 | No. 6 | No. 7 | No. 8 | No. 9 | No. 10 |
|---|---|---|---|---|---|---|---|---|---|---|
| SiO₂ | 55.0 | 47.0 | 39.0 | 39.0 | 47.0 | 47.0 | 43.0 | 39.0 | 39.0 | 55.0 |
| Al₂O₃ | 15.0 | 15.0 | 15.0 | 10.0 | 15.0 | 15.0 | 15.0 | 15.0 | 23.0 | 7.0 |
| B₂O₃ | 22.0 | 22.0 | 22.0 | 22.0 | 22.0 | 22.0 | 22.0 | 22.0 | 22.0 | 22.0 |
| MgO | 6.4 | 6.4 | 6.4 | 6.4 | 6.4 | 6.4 | 6.4 | 6.4 | 6.4 | 6.4 |
| CaO | 1.5 | 1.5 | 1.5 | 1.5 | 1.5 | 1.5 | 1.5 | 1.5 | 1.5 | 1.5 |
| SrO | — | — | — | — | — | — | — | 8.0 | — | — |
| BaO | — | — | 8.0 | 13.0 | — | — | — | — | — | — |
| ZrO₂ | 0.1 | 4.1 | 4.1 | 4.1 | 8.1 | 0.1 | 6.1 | 4.1 | 4.1 | 4.1 |
| TiO₂ | — | 4.0 | 4.0 | 4.0 | 0.0 | 8.0 | 6.0 | 4.0 | 4.0 | 4.0 |
| ρ (g/cm³) | 2.303 | 2.419 | — | — | — | — | — | — | 2.492 | 2.34 |
| Ps (° C.) | 613 | 607 | 602 | 598 | 614 | 601 | 602 | 601 | 630 | 573 |
| Ta (° C.) | 666 | 655 | 641 | 634 | 663 | 650 | 649 | 639 | 673 | 636 |
| Ts (° C.) | — | — | — | — | — | — | — | — | — | — |
| 10^{4.0} dPa · s (° C.) | 1,181 | 1,096 | 1,031 | 997 | 1,281 | 1,084 | 1,105 | 1,015 | 1,060 | 1,241 |
| 10^{3.0} dPa · s (° C.) | 1,331 | 1,224 | 1,147 | 1,108 | 1,320 | 1,210 | 1,197 | 1,129 | 1,162 | 1,336 |
| 10^{2.5} dPa · s (° C.) | 1,428 | 1,309 | 1,225 | 1,183 | 1,358 | 1,297 | 1,268 | 1,202 | 1,231 | 1,412 |
| 10^{2.0} dPa · s (° C.) | 1,548 | 1,414 | 1,327 | 1,278 | 1,430 | 1,413 | 1,363 | 1,295 | 1,315 | 1,528 |
| TL (° C.) | 1,118 | 1,336< | 1,337< | 1,336< | 1,339< | 1,222 | 1,341< | 1,337< | 1,287 | — |
| logηTL (dPa · s) | 4.6 | <2.4 | <2.0 | — | <3.0 | 2.9 | <2.1 | — | 2.2 | — |
| TP (° C.) | 1,073 | 1,082 | — | — | — | — | — | — | 956 | 1,193< |
| logηTP (dPa · s) | 5.1 | 4.2 | — | — | — | — | — | — | 5.6 | <4.5 |
| Refractive | 1.503 | 1.541 | 1.559 | 1.565 | — | — | — | 1.561 | 1.557 | — |
| index n_{d} | | | | | | | | | | |
| Phase | ∘ | ∘ | x | ∘ | ∘ | ∘ | ∘ | x | ∘ | ∘ |
| separation | | | | | | | | | | |
| property | | | | | | | | | | |
| (after | | | | | | | | | | |
| forming) | | | | | | | | | | |
| Phase | ∘ | ∘ | ∘ | ∘ | ∘ | ∘ | ∘ | ∘ | ∘ | ∘ |
| separation | | | | | | | | | | |
| property | | | | | | | | | | |
| (after heat | | | | | | | | | | |
| treatment) | | | | | | | | | | |

TABLE 2

| (wt %) | No. 11 | No. 12 | No. 13 | No. 14 | No. 15 | No. 16 | No. 17 | No. 18 | No. 19 | No. 20 |
|---|---|---|---|---|---|---|---|---|---|---|
| SiO₂ | 47.0 | 55.0 | 47.0 | 39.0 | 47.0 | 51.0 | 51.0 | 43.0 | 43.0 | 47.0 |
| Al₂O₃ | 23.0 | 15.0 | 7.0 | 15.0 | 19.0 | 11.0 | 15.0 | 19.0 | 15.0 | 11.0 |
| B₂O₃ | 14.0 | 14.0 | 30.0 | 30.0 | 18.0 | 22.0 | 18.0 | 22.0 | 26.0 | 26.0 |
| MgO | 6.4 | 6.4 | 6.4 | 6.4 | 6.4 | 6.4 | 6.4 | 6.4 | 6.4 | 6.4 |
| CaO | 1.5 | 1.5 | 1.5 | 1.5 | 1.5 | 1.5 | 1.5 | 1.5 | 1.5 | 1.5 |
| SrO | — | — | — | — | — | — | — | — | — | — |
| BaO | — | — | — | — | — | — | — | — | — | — |
| ZrO₂ | 4.1 | 4.1 | 4.1 | 4.1 | 4.1 | 4.1 | 4.1 | 4.1 | 4.1 | 4.1 |
| TiO₂ | 4.0 | 4.0 | 4.0 | 4.0 | 4.0 | 4.0 | 4.0 | 4.0 | 4.0 | 4.0 |
| ρ (g/cm³) | 2.515 | 2.438 | 2.323 | 2.397 | 2.464 | 2.383 | 2.431 | 2.455 | 2.408 | 2.374 |
| Ps (° C.) | 665 | 659 | 571 | 586 | 638 | 589 | 627 | 618 | 593 | 581 |
| Ta (° C.) | 710 | 707 | 611 | 627 | 683 | 641 | 673 | 663 | 637 | 626 |
| Ts (° C.) | — | 1,039 | — | — | — | — | 1,019 | 975 | — | — |
| 10^{4.0} dPa · s | 1,127 | 1,175 | 1,180 | 1,016 | 1,103 | 1,133 | 1,135 | 1,071 | 1,079 | 1,090 |
| (° C.) | | | | | | | | | | |
| 10^{3.0} dPa · s | 1,243 | 1,311 | 1,263 | 1,032 | 1,224 | 1,259 | 1,266 | 1,187 | 1,178 | 1,214 |
| (° C.) | | | | | | | | | | |
| 10^{2.5} dPa · s | 1,320 | 1,401 | 1,335 | 1,208 | 1,305 | 1,348 | 1,355 | 1,265 | 1,262 | 1,299 |
| (° C.) | | | | | | | | | | |
| 10^{2.0} dPa · s | 1,414 | 1,510 | 1,452 | 1,302 | 1,404 | 1,459 | 1,465 | 1,365 | 1,363 | 1,408 |
| (° C.) | | | | | | | | | | |
| TL (° C.) | 1,402< | 1,410< | — | 1,410< | 1,433< | — | 1,402< | 1,410< | 1,402< | — |
| logηTL (dPa · s) | <2.1 | <2.5 | — | — | <1.9 | — | <2.3 | <1.8 | <1.8 | — |
| TP (° C.) | 1,001 | 1,124 | 1,193< | 1,049 | 1,040 | 1,193< | 1,112 | 1,016 | 1,071 | 1,193< |
| logηTP (dPa · s) | 5.8 | 4.6 | <3.8 | — | 4.8 | <3.5 | 4.3 | 4.7 | 4.1 | <3.2 |
| Refractive | 1.554 | 1.537 | — | — | 1.547 | — | 1.540 | 1.549 | — | — |
| index n_{d} | | | | | | | | | | |
| Phase | x | ∘ | ∘ | ∘ | ∘ | ∘ | ∘ | ∘ | ∘ | ∘ |
| separation | | | | | | | | | | |
| property (after | | | | | | | | | | |
| forming) | | | | | | | | | | |
| Phase | ∘ | ∘ | ∘ | ∘ | ∘ | ∘ | ∘ | ∘ | ∘ | ∘ |
| separation | | | | | | | | | | |
| property (after | | | | | | | | | | |
| heat treatment) | | | | | | | | | | |

First, glass raw materials were blended so that each glass composition described in Tables 1 and 2 was achieved. After that, the resultant glass batch was fed into a glass melting furnace and melted at 1,500 for 8 hours. Next, the resultant molten glass was poured on a carbon sheet to be formed into a sheet shape, followed by annealing treatment from the strain point to room temperature over 10 hours. Finally, the resultant glass sheet was processed as required and evaluated for its various characteristics.

The density p is a value obtained by measurement using a well-known Archimedes method.

The strain point Ps is a value obtained by measurement based on a method as described in ASTM C336-71. It should be noted that, as the strain point Ps becomes higher, the heat resistance becomes higher.

The annealing point Ta and the softening point Ts are values obtained by measurement based on a method as described in ASTM C338-93.

The temperatures (° C.) at viscosities of 10^{4.0} dPa·s, 10^{3.0} dPa·s, 10^{2.5} dPa·s, and 10^{2.0} dPa·s are values obtained by measurement using a platinum sphere pull up method. It should be noted that, as the viscosity at high temperature becomes lower, the meltability becomes more excellent.

The liquidus temperature TL is a value obtained by measuring a temperature at which crystals of glass deposit when crushed glass powder that has passed through a standard 30-mesh sieve (sieve opening: 500 μm) and remained on a 50-mesh sieve (sieve opening: 300 μm) is placed in a platinum boat and kept in a gradient heating furnace for 24 hours.

The liquidus viscosity log ηTL refers to the viscosity of each glass at its liquidus temperature.

The phase separation temperature TP is a value obtained by measuring a temperature at which white turbidity is clearly observed in each glass when the glass is placed in a platinum boat and re-melted at 1,400° C., and the platinum boat is then moved to a gradient heating furnace and kept in the gradient heating furnace for 5 minutes.

The phase separation viscosity log ηTP is a value obtained by measuring the viscosity of each glass at its phase separation temperature by a platinum sphere pull up method.

The refractive index n_{d} is a value at the d-line measured with a refractometer KPR-2000 manufactured by Shimadzu Corporation. Specifically, the refractive index n_{d} is a value obtained by the following procedure: first, a rectangular parallelepiped sample measuring 25 mm×25 mm×about 3 mm is produced; the sample is subjected to annealing treatment at a cooling rate of 0.1° C./minute in a temperature range of from (annealing point Ta+30° C.) to (strain point Ps−50° C.); and then the refractive index n_{d} is measured in a state in which the sample is immersed in an immersion liquid having a refractive index n_{d} matching to that of the sample.

The phase separation property after forming was evaluated as described below. Each sample, which was obtained by forming the molten glass, followed by the annealing treatment as described above, was visually observed. The case where white turbidity resulting from phase separation was observed was evaluated as “∘”, and the case where no white turbidity resulting from phase separation was observed, and the glass appeared to be transparent was evaluated as “x”. It should be noted that even a glass evaluated as “x” for the phase separation property after forming is considered to be able to be phase separated in an annealing step when the annealing conditions are adjusted.

The phase separation property after heat treatment was evaluated as described below. Each sample after the forming was subjected to heat treatment (at 900° C. for 5 minutes) and down-draw forming, to produce a sample for strain point measurement. The resultant sample was visually observed. The case where white turbidity resulting from phase separation was observed was evaluated as “∘”, and the case where no white turbidity resulting from phase separation was observed, and the glass appeared to be transparent was evaluated as “x”.

### Example 2

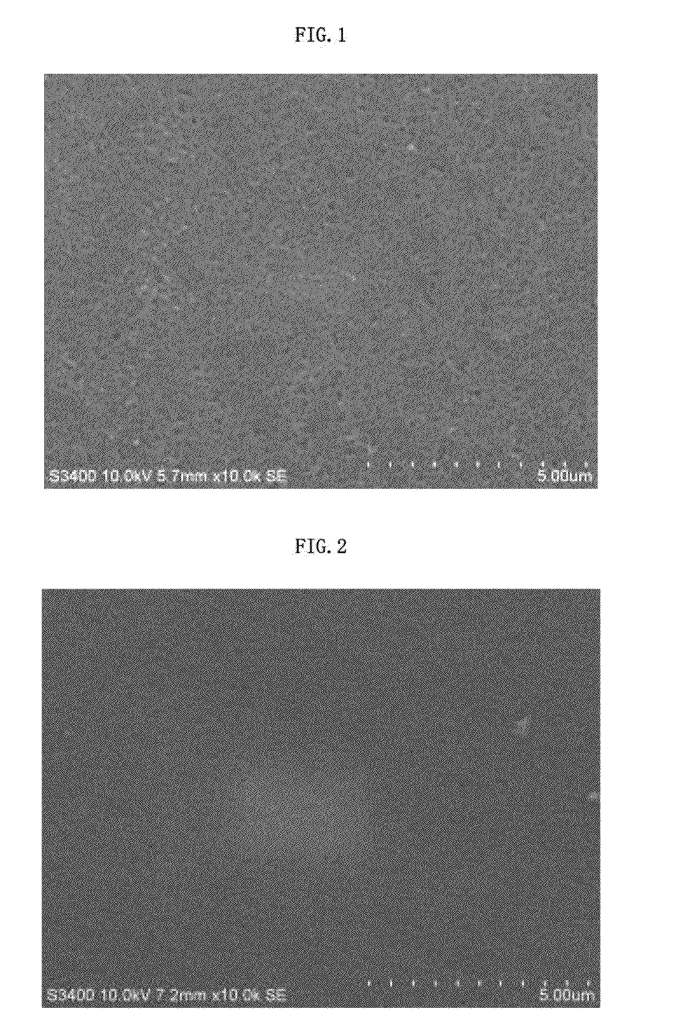

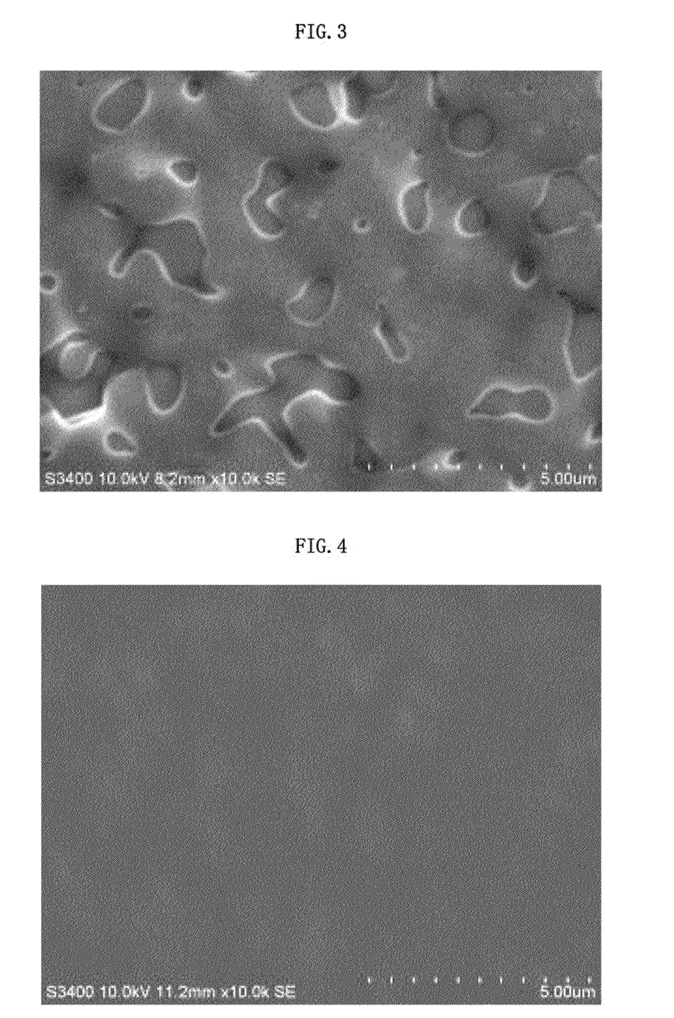

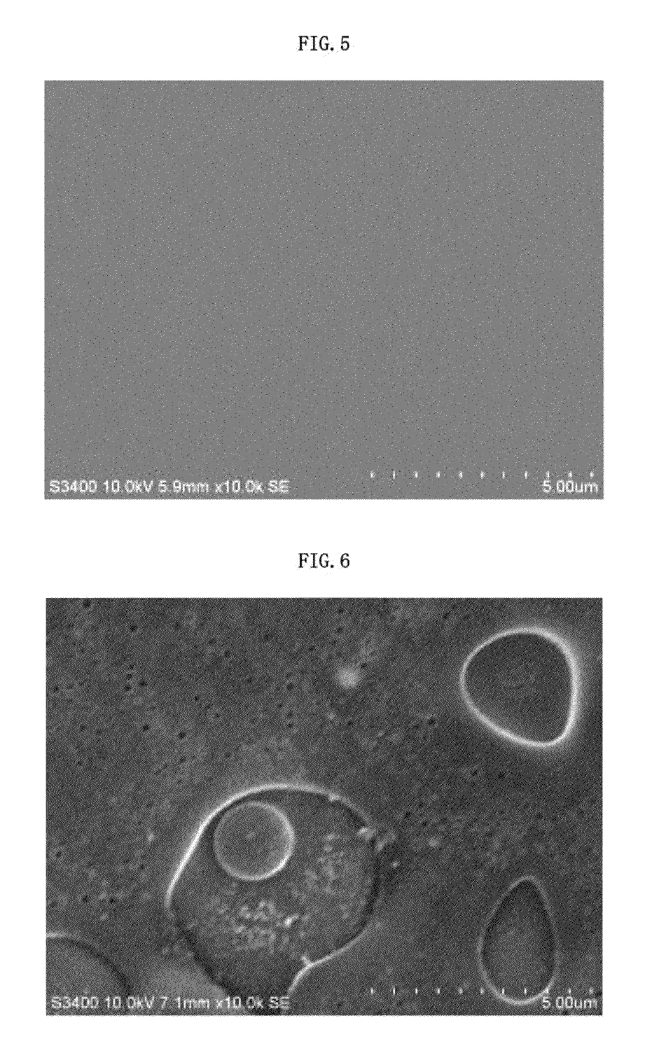

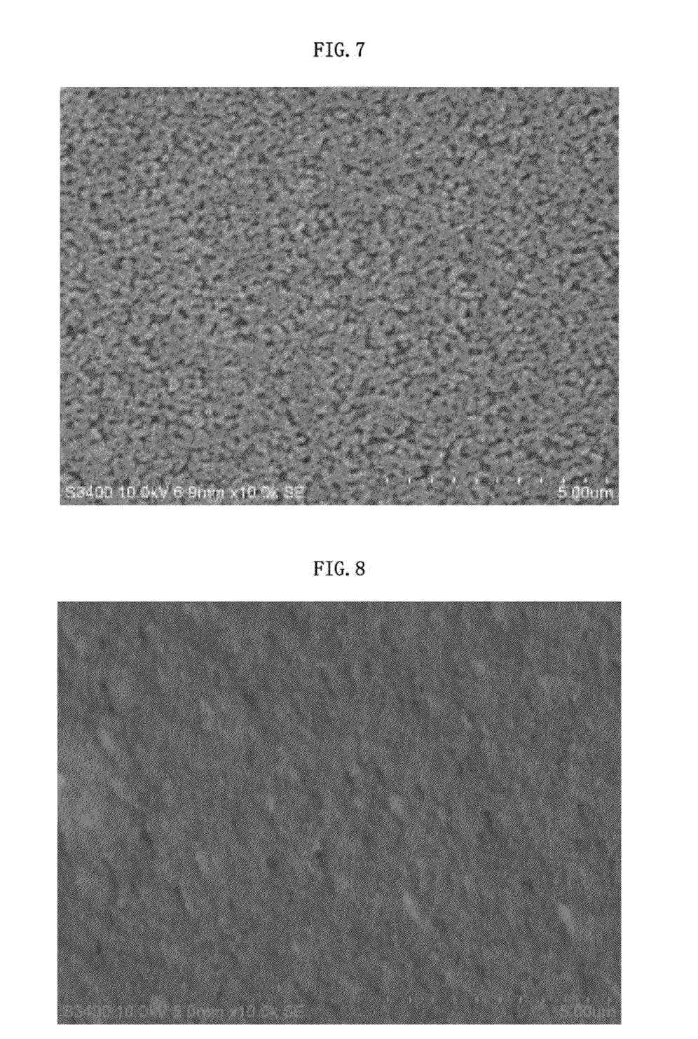

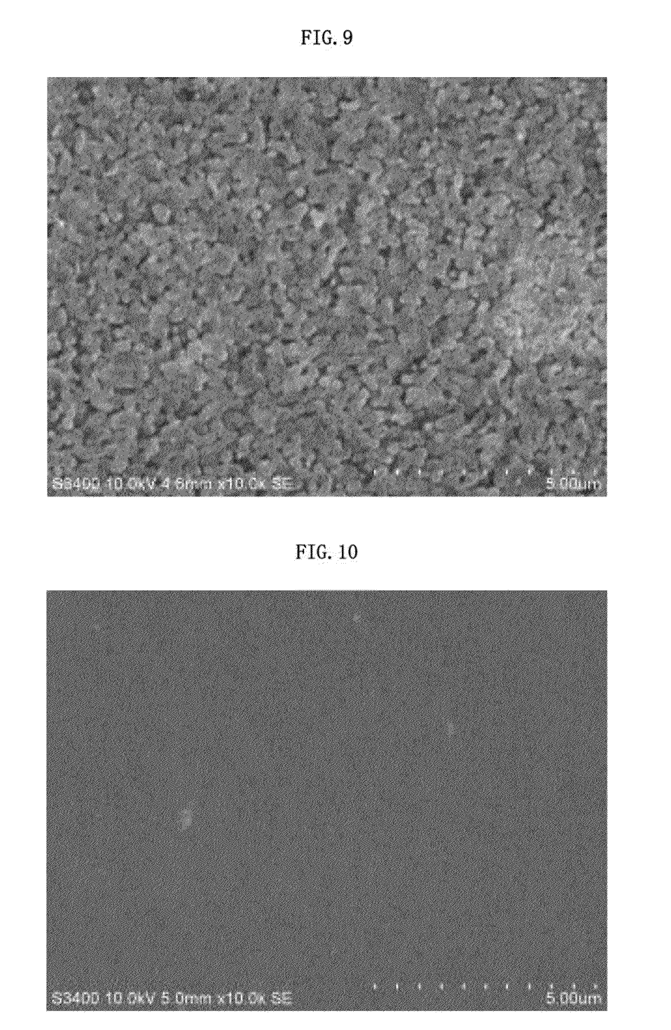

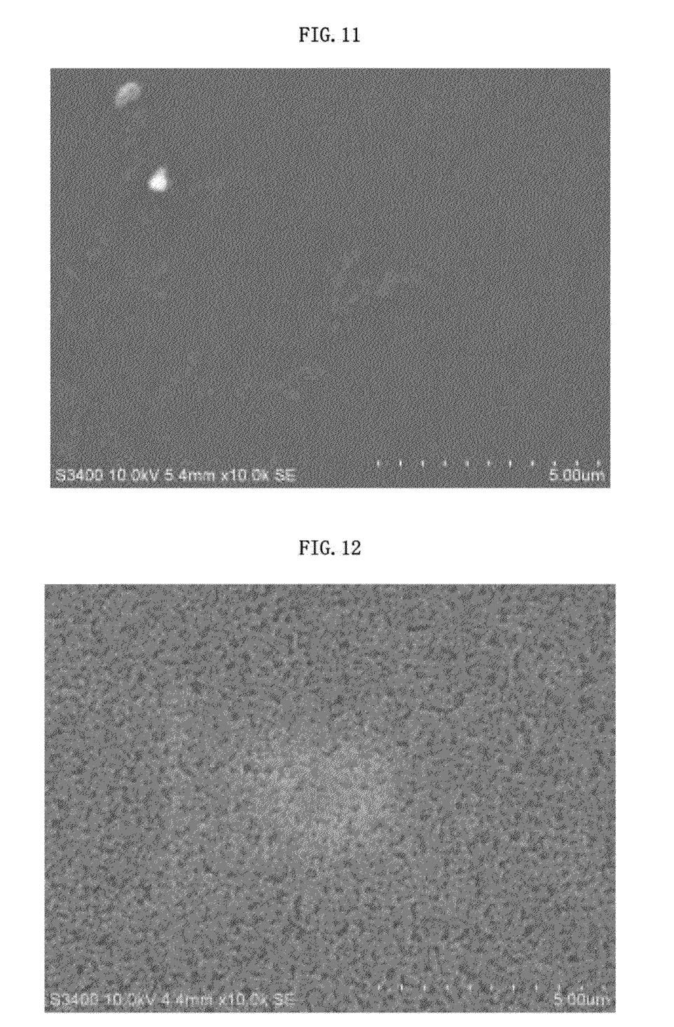

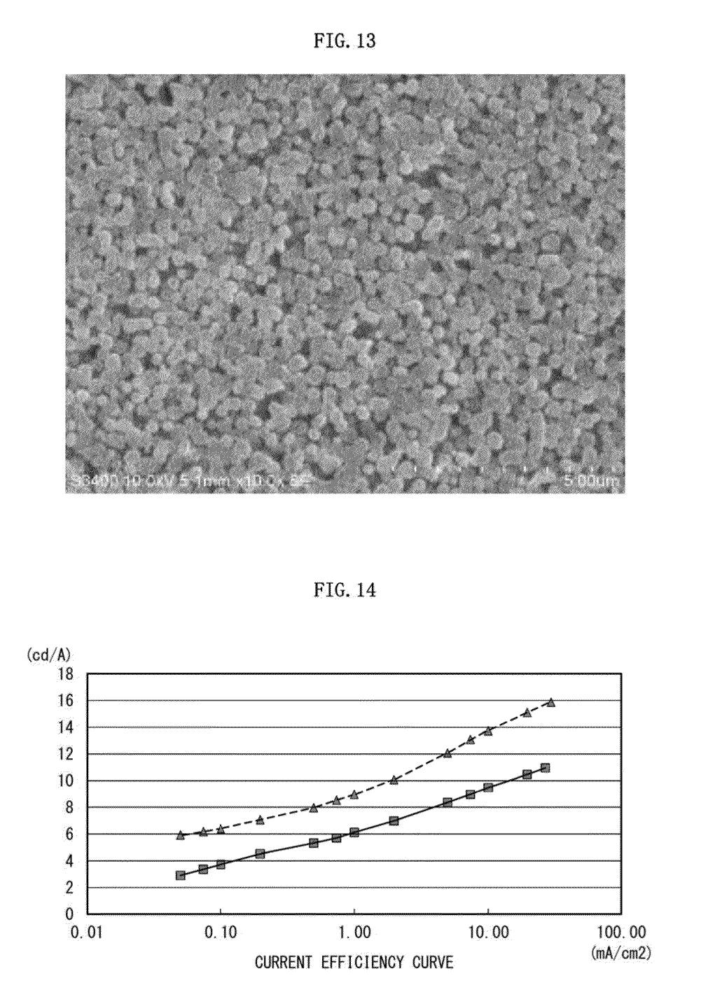

Sample Nos. 2 and 9 to 20, which had not been subjected to the heat treatment, were each immersed in a 1 M hydrochloric acid solution for 10 minutes, and then the surface of each sample was observed with a scanning electron microscope (S-4300SE manufactured by Hitachi High-Technologies Corporation). The results are shown in FIG. 1 to FIG. 13. The scanning electron micrographs of the surfaces of Sample Nos. 2 and 9 to 20 are shown in FIG. 1 to FIG. 13, respectively. As a result, it was found that Sample Nos. 2, 9, 10, and 12 to 20 each had a phase separation structure, and a phase rich in B₂O₃ (second phase: phase poor in SiO₂) was eluted with the hydrochloric acid solution. It should be noted that a phase rich in B₂O₃ is eluted with the hydrochloric acid solution, and a phase rich in SiO₂ is not eluted with the hydrochloric acid solution.

### Example 3

Sample Nos. 2, 12, and 19, which had not been subjected to the heat treatment, were each processed so as to have a sheet thickness of 1.0 mm or 0.7 mm, followed by mirror polishing of both surfaces thereof. Each sample was measured for the total light transmittance and diffuse transmittance in its thickness direction at wavelengths described in the following tables with a spectrophotometer (spectrophotometer UV-2500PC manufactured by Shimadzu Corporation). The results are shown in Tables 3 to 5.

TABLE 3

| | Sheet thickness: | | | Sheet thickness: | | |
|---|---|---|---|---|---|---|
| Measurement | 1.0 mm | | | 0.7 mm | | |
| wavelength: 435 nm | No. 2 | No. 12 | No. 19 | No. 2 | No. 12 | No. 19 |
| Total light | 9 | 44 | 6 | 16 | 54 | 10 |
| transmittance (%) | | | | | | |
| Diffuse | 9 | 19 | 6 | 15 | 15 | 10 |
| transmittance (%) | | | | | | |
| Haze value (%) | 100 | 42 | 100 | 99 | 28 | 100 |

TABLE 4

| | Sheet thickness: | | | Sheet thickness: | | |
|---|---|---|---|---|---|---|
| Measurement | 1.0 mm | | | 0.7 mm | | |
| wavelength: 546 nm | No. 2 | No. 12 | No. 19 | No. 2 | No. 12 | No. 19 |
| Total light | 32 | 77 | 17 | 44 | 81 | 24 |
| transmittance (%) | | | | | | |
| Diffuse | 23 | 6 | 17 | 21 | 4 | 22 |
| transmittance (%) | | | | | | |
| Haze value (%) | 73 | 8 | 99 | 47 | 5 | 93 |

TABLE 5

| | Sheet thickness: | | | Sheet thickness: | | |
|---|---|---|---|---|---|---|
| Measurement | 1.0 mm | | | 0.7 mm | | |
| wavelength: 700 nm | No. 2 | No. 12 | No. 19 | No. 2 | No. 12 | No. 19 |
| Total light | 70 | 88 | 45 | 77 | 88 | 58 |
| transmittance (%) | | | | | | |
| Diffuse | 10 | 5 | 22 | 7 | 4 | 15 |
| transmittance (%) | | | | | | |
| Haze value (%) | 14 | 6 | 49 | 9 | 4 | 26 |

### Example 4

A glass sheet according to Sample No. 12 in Table 2 (sheet thickness: 0.7 mm, not having been subjected to heat treatment after the forming) was produced. ITO (thickness: 100 nm) was deposited as a transparent electrode layer on the surface of the glass sheet through the use of a mask. Next, layers formed of the following materials were formed on the glass sheet: polymer PEDOT-PSS (thickness: 40 nm) as a hole injection layer; α-NPD (thickness: 50 nm) as a hole transport layer; CBP (thickness: 30 nm) doped with 6 mass % of Ir(ppy)₃ as an organic light emitting layer; BAlq (thickness: 10 nm) as a hole blocking layer; Alq (thickness: 30 nm) as an electron transport layer; LiF (thickness: 0.8 nm) as an electron injection layer; and Al (thickness: 150 nm) as a counter electrode. After that, the inside was sealed. Thus, an OLED element was produced. The resultant OLED element was measured for front brightness by arranging a brightness meter (BM-9 manufactured by Topcon Corporation) in a direction perpendicular to a light emitting surface, and evaluated for current efficiency. As Comparative Example, an OLED element produced by incorporating a non-phase separated glass sheet (sheet thickness: 0.7 mm) having a refractive index n_{d} comparable to that of the glass sheet according to Sample No. 12 was measured for front brightness and evaluated for current efficiency in the same manner. The results are shown in Table 6 and FIG. 14. In FIG. 14, the upper current efficiency curve corresponds to Example of the present invention, and the lower current efficiency curve corresponds to Comparative Example. It should be noted that the glass of Comparative Example comprises as a glass composition, in terms of mass %, 49.8% of SiO₂, 23% of Al₂O₃, 14% of B₂O₃, 6.4% of MgO, 1.5% of CaO, 2.7% of ZrO₂, and 2.6% of TiO₂, and has a refractive index n_{d} of 1.54.

TABLE 6

| | |
|---|---|
| No. 12 | Comparative Example |

| Current | Current | Current | Current |
|---|---|---|---|
| density | efficiency | density | efficiency |
| (mA/cm²) | (cd/A) | (mA/cm²) | (cd/A) |
| 0.05 | 5.90 | 0.05 | 2.86 |
| 0.08 | 6.16 | 0.08 | 3.34 |
| 0.10 | 6.39 | 0.10 | 3.65 |
| 0.20 | 6.98 | 0.20 | 4.43 |
| 0.50 | 7.92 | 0.50 | 5.30 |
| 0.75 | 8.47 | 0.76 | 5.73 |
| 1.00 | 8.90 | 1.01 | 6.06 |
| 2.00 | 10.10 | 2.01 | 6.94 |
| 5.00 | 12.08 | 5.04 | 8.34 |
| 7.50 | 13.03 | 7.55 | 8.91 |
| 10.00 | 13.73 | 10.07 | 9.40 |
| 20.00 | 15.05 | 20.14 | 10.43 |
| 30.00 | 15.80 | 27.19 | 10.89 |

As apparent from Table 6 and FIG. 14, Sample No. 12 exhibited higher current efficiency than that of Comparative Example when the OLED element was produced. For example, Sample No. 12 exhibited higher current efficiency by about 46% at 10 mA/cm².

### Example 5

A substrate for an OLED element was produced by using the non-phase separated glass sheet (sheet thickness: 0.7 mm) of Comparative Example in [Example 4]. Next, the glass sheet according to Sample No. 12 in Table 2 (sheet thickness: 0.7 mm, not having been subjected to heat treatment after the forming) was arranged on the substrate through an intermediation of an immersion liquid having a refractive index n_{d} of 1.54. After that, the resultant product was measured for the light emission intensity of a light emitting surface with an integrating sphere. As a result, it was found that the resultant product had an intensity 1.2 times as high as that in the case of not arranging the glass sheet according to Sample No. 12 at a peak wavelength of 520 nm.

### Example 6

Next, the present invention (second invention) is described in detail by way of Examples. It should be noted that the following Examples are merely illustrative. The present invention (second invention) is by no means limited to the Examples described below.

Sample Nos. 21 to 40 are shown in Tables 7 and 8.

TABLE 7

| (wt %) | No. 21 | No. 22 | No. 23 | No. 24 | No. 25 | No. 26 | No. 27 | No. 28 | No. 29 | No. 30 |
|---|---|---|---|---|---|---|---|---|---|---|
| SiO₂ | 55.0 | 47.0 | 39.0 | 39.0 | 47.0 | 47.0 | 43.0 | 39.0 | 39.0 | 55.0 |
| Al₂O₃ | 15.0 | 15.0 | 15.0 | 10.0 | 15.0 | 15.0 | 15.0 | 15.0 | 23.0 | 7.0 |
| B₂O₃ | 22.0 | 22.0 | 22.0 | 22.0 | 22.0 | 22.0 | 22.0 | 22.0 | 22.0 | 22.0 |
| MgO | 6.4 | 6.4 | 6.4 | 6.4 | 6.4 | 6.4 | 6.4 | 6.4 | 6.4 | 6.4 |
| CaO | 1.5 | 1.5 | 1.5 | 1.5 | 1.5 | 1.5 | 1.5 | 1.5 | 1.5 | 1.5 |
| SrO | — | — | — | — | — | — | — | 8.0 | — | — |
| BaO | — | — | 8.0 | 13.0 | — | — | — | — | — | — |
| ZrO₂ | 0.1 | 4.1 | 4.1 | 4.1 | 8.1 | 0.1 | 6.1 | 4.1 | 4.1 | 4.1 |
| TiO₂ | — | 4.0 | 4.0 | 4.0 | 0.0 | 8.0 | 6.0 | 4.0 | 4.0 | 4.0 |
| ρ (g/cm³) | 2.303 | 2.419 | — | — | — | — | — | — | 2.492 | 2.34 |
| Ps (° C.) | 613 | 607 | 602 | 598 | 614 | 601 | 602 | 601 | 630 | 573 |
| Ta (° C.) | 666 | 655 | 641 | 634 | 663 | 650 | 649 | 639 | 673 | 636 |
| Ts (° C.) | — | — | — | — | — | — | — | — | — | — |
| 10^{4.0} dPa · s | 1,181 | 1,096 | 1,031 | 997 | 1,281 | 1,084 | 1,105 | 1,015 | 1,060 | 1,241 |
| (° C.) | | | | | | | | | | |
| 10^{3.0} dPa · s | 1,331 | 1,224 | 1,147 | 1,108 | 1,320 | 1,210 | 1,197 | 1,129 | 1,162 | 1,336 |
| (° C.) | | | | | | | | | | |
| 10^{2.5} dPa · s | 1,428 | 1,309 | 1,225 | 1,183 | 1,358 | 1,297 | 1,268 | 1,202 | 1,231 | 1,412 |
| (° C.) | | | | | | | | | | |
| 10^{2.0} dPa · s | 1,548 | 1,414 | 1,327 | 1,278 | 1,430 | 1,413 | 1,363 | 1,295 | 1,315 | 1,528 |
| (° C.) | | | | | | | | | | |
| TL (° C.) | 1,118 | 1,336< | 1,337< | 1,336< | 1,339< | 1,222 | 1,341< | 1,337< | 1,287 | — |
| logηTL | 4.6 | <2.4 | <2.0 | — | <3.0 | 2.9 | <2.1 | — | 2.2 | — |
| (dPa · s) | | | | | | | | | | |
| Refractive | 1.503 | 1.541 | 1.559 | 1.565 | — | — | — | 1.561 | 1.557 | — |
| index n_{d} | | | | | | | | | | |
| Phase | ∘ | ∘ | x | ∘ | ∘ | ∘ | ∘ | x | ∘ | ∘ |
| separation | | | | | | | | | | |
| property | | | | | | | | | | |
| (after | | | | | | | | | | |
| forming) | | | | | | | | | | |
| Phase | ∘ | ∘ | ∘ | ∘ | ∘ | ∘ | ∘ | ∘ | ∘ | ∘ |
| separation | | | | | | | | | | |
| property | | | | | | | | | | |
| (after heat | | | | | | | | | | |
| treatment) | | | | | | | | | | |

TABLE 8

| (wt %) | No. 31 | No. 32 | No. 33 | No. 34 | No. 35 | No. 36 | No. 37 | No. 38 | No. 39 | No. 40 |
|---|---|---|---|---|---|---|---|---|---|---|
| SiO₂ | 47.0 | 55.0 | 47.0 | 39.0 | 47.0 | 51.0 | 51.0 | 43.0 | 43.0 | 47.0 |
| Al₂O₃ | 23.0 | 15.0 | 7.0 | 15.0 | 19.0 | 11.0 | 15.0 | 19.0 | 15.0 | 11.0 |
| B₂O₃ | 14.0 | 14.0 | 30.0 | 30.0 | 18.0 | 22.0 | 18.0 | 22.0 | 26.0 | 26.0 |
| MgO | 6.4 | 6.4 | 6.4 | 6.4 | 6.4 | 6.4 | 6.4 | 6.4 | 6.4 | 6.4 |
| CaO | 1.5 | 1.5 | 1.5 | 1.5 | 1.5 | 1.5 | 1.5 | 1.5 | 1.5 | 1.5 |
| SrO | — | — | — | — | — | — | — | — | — | — |
| BaO | — | — | — | — | — | — | — | — | — | — |
| ZrO₂ | 4.1 | 4.1 | 4.1 | 4.1 | 4.1 | 4.1 | 4.1 | 4.1 | 4.1 | 4.1 |
| TiO₂ | 4.0 | 4.0 | 4.0 | 4.0 | 4.0 | 4.0 | 4.0 | 4.0 | 4.0 | 4.0 |
| ρ (g/cm³) | 2.515 | 2.438 | 2.323 | 2.397 | 2.464 | 2.383 | 2.431 | 2.455 | 2.408 | 2.374 |
| Ps (° C.) | 665 | 659 | 571 | 586 | 638 | 589 | 627 | 618 | 593 | 581 |
| Ta (° C.) | 710 | 707 | 611 | 627 | 683 | 641 | 673 | 663 | 637 | 626 |
| Ts (° C.) | — | 1,039 | — | — | — | — | 1,019 | 975 | — | — |
| 10^{4.0} dPa · s | 1,127 | 1,175 | 1,180 | 1,016 | 1,103 | 1,133 | 1,135 | 1,071 | 1,079 | 1,090 |
| (° C.) | | | | | | | | | | |
| 10^{3.0} dPa · s | 1,243 | 1,311 | 1,263 | 1,032 | 1,224 | 1,259 | 1,266 | 1,187 | 1,178 | 1,214 |
| (° C.) | | | | | | | | | | |
| 10^{2.5} dPa · s | 1,320 | 1,401 | 1,335 | 1,208 | 1,305 | 1,348 | 1,355 | 1,265 | 1,262 | 1,299 |
| (° C.) | | | | | | | | | | |
| 10^{2.0} dPa · s | 1,414 | 1,510 | 1,452 | 1,302 | 1,404 | 1,459 | 1,465 | 1,365 | 1,363 | 1,408 |
| (° C.) | | | | | | | | | | |
| TL (° C.) | 1,402< | 1,410< | — | 1,410< | — | — | 1,402< | 1,410< | 1,402< | — |
| logηTL | <2.1 | <2.5 | — | — | — | — | <2.3 | — | — | — |
| (dPa · s) | | | | | | | | | | |
| Refractive | 1.554 | 1.537 | — | — | 1.547 | — | 1.540 | 1.549 | — | — |
| index n_{d} | | | | | | | | | | |
| Phase | x | ∘ | ∘ | ∘ | ∘ | ∘ | ∘ | ∘ | ∘ | ∘ |
| separation | | | | | | | | | | |
| property | | | | | | | | | | |
| (after | | | | | | | | | | |
| forming) | | | | | | | | | | |
| Phase | ∘ | ∘ | ∘ | ∘ | ∘ | ∘ | ∘ | ∘ | ∘ | ∘ |
| separation | | | | | | | | | | |
| property | | | | | | | | | | |
| (after heat | | | | | | | | | | |
| treatment) | | | | | | | | | | |

First, glass raw materials were blended so that each glass composition described in Tables 7 and 8 was achieved. After that, the resultant glass batch was fed into a glass melting furnace and melted at 1,500 for 8 hours. Next, the resultant molten glass was poured on a carbon sheet to be formed into a sheet shape, followed by simple annealing treatment from the strain point to room temperature over 10 hours. Finally, the resultant glass sheet was processed as required and evaluated for its various characteristics.

The density p is a value obtained by measurement using a well-known Archimedes method.

The strain point Ps is a value obtained by measurement based on a method as described in ASTM C336-71. It should be noted that, as the strain point Ps becomes higher, the heat resistance becomes higher.

The annealing point Ta and the softening point Ts are values obtained by measurement based on a method as described in ASTM C338-93.

The temperatures (° C.) at viscosities of 10^{4.0} dPa·s, 10^{3.0} dPa·s, 10^{2.5} dPa·s, and 10^{2.0} dPa·s are values obtained by measurement using a platinum sphere pull up method. It should be noted that, as the viscosity at high temperature becomes lower, the meltability becomes more excellent.

The liquidus temperature TL is a value obtained by measuring a temperature at which crystals of glass deposit when crushed glass powder that has passed through a standard 30-mesh sieve (sieve opening: 500 μm) and remained on a 50-mesh sieve (sieve opening: 300 μm) is placed in a platinum boat and kept in a gradient heating furnace for 24 hours.

The liquidus viscosity log ηTL refers to the viscosity of each glass at its liquidus temperature.

The refractive index n_{d} is a value at the d-line measured with a refractometer KPR-2000 manufactured by Shimadzu Corporation. Specifically, the refractive index n_{d} is a value obtained by the following procedure: first, a rectangular parallelepiped sample measuring 25 mm×25 mm×about 3 mm is produced; the sample is subjected to annealing treatment at a cooling rate of 0.1° C./minute in a temperature range of from (annealing point Ta+30° C.) to (strain point Ps−50° C.); and then the refractive index n_{d} is measured in a state in which the sample is immersed in an immersion liquid having a refractive index n_{d} matching to that of the sample.

The phase separation property after forming was evaluated as described below. Each sample, which was obtained by forming the molten glass, followed by the above-mentioned simple annealing treatment, was visually observed. The case where white turbidity resulting from phase separation was observed was evaluated as “∘”, and the case where no white turbidity resulting from phase separation was observed, and the glass appeared to be transparent was evaluated as “x”.

The phase separation property after heat treatment was evaluated as described below. Each sample after the forming was subjected to heat treatment (at 900° C. for 5 minutes) and down-draw forming, to produce a sample for strain point measurement. The resultant sample was visually observed. The case where white turbidity resulting from phase separation was observed was evaluated as “∘”, and the case where no white turbidity resulting from phase separation was observed, and the glass appeared to be transparent was evaluated as “x”.

### Example 7

For reference, Sample Nos. 22 and 29 to 40 after the forming and before heat treatment were each observed with a scanning electron microscope for the phase separation property. Specifically, Sample Nos. 22 and 29 to 40 after the forming and the above-mentioned simple annealing treatment were each immersed in a 1 M hydrochloric acid solution for 10 minutes, and then the surface of each sample was observed with a scanning electron microscope (S-4300SE manufactured by Hitachi High-Technologies Corporation). Also in the scanning electron micrographs of the surfaces of Sample Nos. 22 and 29 to 40, aspects similar to those shown in FIG. 1 to FIG. 13 in Example 2 described above were shown. As a result, it was found that Sample Nos. 22, 29, 30, and 32 to 40 each had a phase separation structure, and a phase rich in B₂O₃ (second phase: phase poor in SiO₂) was eluted with the hydrochloric acid solution. It should be noted that a phase rich in B₂O₃ is eluted with the hydrochloric acid solution, and a phase rich in SiO₂ is not eluted with the hydrochloric acid solution.

### Example 8

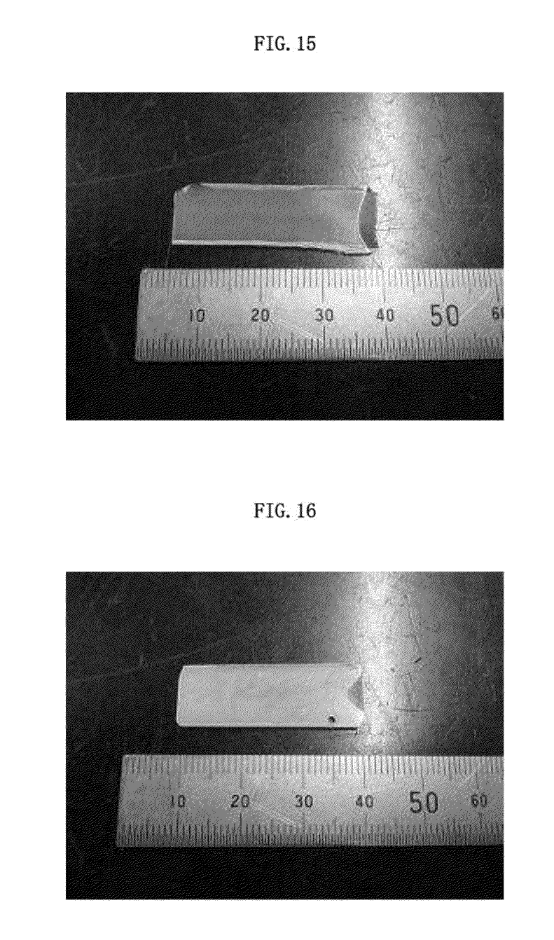

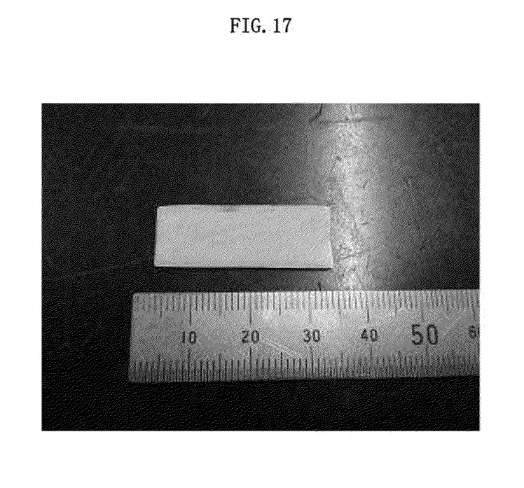

Sample No. 39 after the forming was placed in a platinum boat having a size of about 15 mm×130 mm. The platinum boat was placed in an electric furnace, and the glass was re-melted at 1,400° C. It should be noted that the glass re-melted in the platinum boat had a thickness of from about 3 mm to about 5 mm. After the re-melting, the platinum boat was taken out from the electric furnace, and left to cool in air. The resultant glass was subjected to heat treatment under the conditions of 840° C. and 20 minutes or 840° C. and 40 minutes. The glass after the heat treatment was processed into a glass sheet measuring about 10 mm×30 mm×1.0 mm in thickness, followed by mirror polishing of both surfaces thereof. The glass sheet was measured for the total light transmittance and diffuse transmittance in its thickness direction at wavelengths described in the following tables with a spectrophotometer (spectrophotometer UV-2500PC manufactured by Shimadzu Corporation). The results are shown in Tables 9 to 11. Further, the glass not subjected to the heat treatment was processed into a glass sheet measuring about 10 mm×30 mm×1.0 mm in thickness, followed by mirror polishing of both surfaces thereof. A photograph of the external appearance of the glass sheet is shown in FIG. 15. Further, a photograph of the external appearance of the glass sheet in the case where the glass is subjected to heat treatment at 840° C. for 20 minutes, followed by processing into a glass sheet measuring about 10 mm×30 mm×1.0 mm in thickness and mirror polishing of both surfaces thereof is shown in FIG. 16, and a photograph of the external appearance of the glass sheet in the case where the glass is subjected to heat treatment at 840° C. for 40 minutes, followed by processing into a glass sheet measuring about 10 mm×30 mm×1.0 mm in thickness and mirror polishing of both surfaces thereof is shown in FIG. 17.

TABLE 9

| | Heat treatment conditions | | |
|---|---|---|---|
| | No heat | 840° C. for | 840° C. for |
| Wavelength: 435 nm | treatment | 20 minutes | 40 minutes |
| Total light | 50 | 23 | 13 |
| transmittance (%) | | | |
| Diffuse | 24 | 23 | 13 |
| transmittance (%) | | | |
| Haze value (%) | 49 | 100 | 100 |

TABLE 10

| | Heat treatment conditions | | |
|---|---|---|---|
| | No heat | 840° C. for | 840° C. for |
| Wavelength: 546 nm | treatment | 20 minutes | 40 minutes |
| Total light | 78 | 52 | 34 |
| transmittance (%) | | | |
| Diffuse | 6 | 24 | 30 |
| transmittance (%) | | | |
| Haze value (%) | 8 | 46 | 89 |

TABLE 11

| | Heat treatment conditions | | |
|---|---|---|---|
| | No heat | 840° C. for | 840° C. for |
| Wavelength: 700 nm | treatment | 20 minutes | 40 minutes |
| Total light | 89 | 78 | 64 |
| transmittance (%) | | | |
| Diffuse | 3 | 8 | 20 |
| transmittance (%) | | | |
| Haze value (%) | 3 | 10 | 32 |

1. A glass, which has a phase separation structure comprising at least a first phase and a second phase, and is used for an OLED device,
wherein a content of SiO₂ in the first phase is higher than a content of SiO₂ in the second phase.

2. A glass, which has a phase separation structure comprising at least a first phase and a second phase, and is used for an OLED device,
wherein a content of B₂O₃ in the second phase is higher than a content of B₂O₃ in the first phase.

3. The glass according to claim 1 or 2, wherein the glass comprises as a glass composition, in terms of mass %, 30% to 75% of SiO₂, 0.1% to 50% of B₂O₃, and 0% to 35% of Al₂O₃.

4. The glass according to claim 1 or 2, wherein the glass is substantially free of a rare metal oxide in a glass composition.

5. The glass according to claim 1 or 2, wherein the glass has a refractive index n_{d} of more than 1.50.

6. The glass according to claim 1 or 2, wherein the glass has a flat sheet shape.

7. The glass according to claim 1 or 2, wherein the glass is formed by an overflow down-draw method.

8. The glass according to claim 1 or 2, wherein the glass is obtained without an additional heat treatment step.

9. (canceled)

10. The glass according to claim 1 or 2, wherein the glass has a phase separation viscosity of 10^{7.0} dPa·s or less.

11. The glass according to claim 1 or 2, wherein the glass has a haze value of from 1% to 100% at each wavelength of 435 nm, 546 nm, and 700 nm.

12. The glass according to claim 1 or 2, wherein the glass exhibits higher current efficiency than current efficiency of a non-phase separated glass having a comparable refractive index n_{d} when incorporated into an OLED element.

13. An OLED device, comprising the glass of claim 1 or 2.

14. A composite substrate, comprising a glass sheet and a substrate bonded to each other,
wherein the glass sheet comprises the glass of claim 1 or 2.

15. The composite substrate according to claim 14, wherein the substrate comprises a glass substrate.

16. The composite substrate according to claim 14, wherein the substrate has a refractive index n_{d} of more than 1.50.

17. The composite substrate according to claim 14, wherein the glass sheet and the substrate are bonded to each other through optical contact.

18. (canceled)

19. A method of producing a glass, the method comprising:
forming molten glass; and
performing heat treatment on the resultant, to thereby obtain a glass which has a phase separation structure comprising at least a first phase and a second phase, and is used for an OLED device.

20. The method of producing a glass according to claim 19, wherein a content of SiO₂ in the first phase is higher than a content of SiO₂ in the second phase.

21. The method of producing a glass according to claim 19, wherein a content of B₂O₃ in the second phase is higher than a content of B₂O₃ in the first phase.

22. The method of producing a glass according to claim 19, wherein the glass comprises as a glass composition, in terms of mass %, 30% to 75% of SiO₂, 0.1% to 50% of B₂O₃, and 0% to 35% of Al₂O₃.

23. The method of producing a glass according to claim 22, wherein the glass is substantially free of a rare metal oxide in a glass composition.

24. The method of producing a glass according to claim 19, wherein the glass has a refractive index n_{d} of more than 1.50.

25. The method of producing a glass according to claim 19, wherein the forming comprises forming the molten glass into a flat sheet shape.

26. The method of producing a glass according to claim 19, wherein the forming is performed by an overflow down-draw method.

27. (canceled)

28. A glass, which is produced by the method of producing a glass of claim 22.

29. A glass, which has a property of being phase separated into at least a first phase and a second phase from a non-phase separated state through heat treatment, and is used for an OLED device.

30. The glass according to claim 28 or 29, wherein the glass has a haze value of from 5% to 100% at each wavelength of 435 nm, 546 nm, and 700 nm before the heat treatment.

31. The glass according to claim 28 or 29, wherein the glass has a haze value of from 0% to 80% at each wavelength of 435 nm, 546 nm, and 700 nm after the heat treatment.
